(19) United States
(12) Patent Application Publication
(10) Pub. No.: US 2026/0160383 A1
(43) Pub. Date: Jun. 11, 2026

(54) Top Mounting Structure for Display Device

(71) Applicant: NINGBO TUOTUO RIVER DESIGN COMPANY, NINGBO (CN)

(72) Inventors: Xiaodong YOU, NINGBO (CN); Hongjun WANG, NINGBO (CN); Zhimin WANG, NINGBO (CN); Hanxing HONG, NINGBO (CN); Hailei CAI, NINGBO (CN)

(21) Appl. No.: 19/178,741

(22) Filed: Apr. 14, 2025

(30) Foreign Application Priority Data
Apr. 15, 2024 (CN) 202420767144.9
Aug. 2, 2024 (CN) 202421869511.2
Jan. 22, 2025 (CN) 202520156371.2

(51) Int. Cl. F16M 13/02; F16M 11/10; F16M 11/18; F16M 11/20; F16M 11/38

(52) U.S. Cl. CPC F16M 13/027; F16M 11/10; F16M 11/18; F16M 11/2014; F16M 11/38; F16M 2200/045

(57) ABSTRACT

A top mounting structure for a display device includes: a top mounting bracket and a connecting assembly, where the connecting assembly includes a rotating mechanism and a deployment and retraction mechanism; and the top mounting bracket is used to be fixedly connected with a top ceiling. The rotating mechanism is rotatably connected with the top mounting bracket; and the deployment and retraction mechanism is arranged below the rotating mechanism, and an upper portion of the deployment and retraction mechanism is connected with the rotating mechanism. The deployment and retraction mechanism includes a telescopic part and a movable arm that are connected with each other, where the telescopic part is capable of driving the movable arm to rotate relative to the top mounting bracket, and the movable arm is configured for being directly or indirectly connected with the display device.

### CROSS-REFERENCE TO RELATED APPLICATIONS

The disclosure claims the priority to Patent Application No. 202420767144.9, filed with the China National Intellectual Property Administration on Apr. 15, 2024 and entitled “Top mounting structure for display device”.

The disclosure claims the priority to Patent Application No. 202421869511.2, filed with the China National Intellectual Property Administration on Aug. 2, 2024 and entitled “Top mounting structure for display device”.

The disclosure claims the priority to Patent Application No. 202520156371.2, filed with the China National Intellectual Property Administration on Jan. 22, 2025 and entitled “Mounting support”.

### TECHNICAL FIELD

The disclosure relates to the technical field of television supports, and particularly relates to a top mounting structure for a display device.

### BACKGROUND

A top mounting structure for a display device is a supporting bracket for mounting a television onto a top ceiling. The top mounting structure for the display device generally includes a base fixed to the top ceiling, a fixing plate for fixing the television, and a foldable deployment and retraction mechanism for connecting the base with the fixing plate.

In the related art, an angle of the top mounting structure for the display device is adjusted manually or electrically, and merely adjustment of open and retraction in a direction with a single degree of freedom is practicable. A user cannot watch the television at any other angles except directly in front of the top mounting structure for the display device. Thus, multi-angle and multi-range applications are unachievable.

### SUMMARY

An objective of examples of the disclosure is to provide a top mounting structure for a display device, such that multi-degree-of-freedom adjustment is able to be conducted, and multi-angle and multi-range applications of the top mounting structure for the display device are able to be implemented. A specific technical solution is as follows:

An example of the disclosure provides a top mounting structure for a display device. The top mounting structure for the display device includes: a top mounting bracket, a rotating mechanism, and an deployment and retraction mechanism, the top mounting bracket is used to be fixedly connected with a top ceiling, the rotating mechanism is rotatably connected with the top mounting bracket, the deployment and retraction mechanism is arranged below the rotating mechanism, and an upper portion of the deployment and retraction mechanism is connected with the rotating mechanism, the deployment and retraction mechanism includes a telescopic part and a movable arm that are connected with each other, the telescopic part is capable of driving the movable arm to rotate relative to the top mounting bracket, and the movable arm is suitable for being directly or indirectly connected to the display device. In this way, a pitch angle of the display device relative to the top mounting bracket is adjusted.

In some examples of the disclosure, the top mounting structure further includes a television mounting bracket, the television mounting bracket is fixedly or rotatably connected with the movable arm, the television mounting bracket is configured for mounting the display device.

In some examples of the disclosure, the top mounting structure further includes a mounting frame, the rotating mechanism is fixedly arranged on the mounting frame, The telescopic part is an electric push rod, a first end of the electric push rod is hinged to the mounting frame, and a second end of the electric push rod is hinged to the movable arm, the electric push rod extends and shortens to adjust an included angle between the movable arm and the mounting frame.

In some examples of the disclosure, the top mounting bracket includes: a top plate and a connecting mechanism, the top plate is used to be fixedly connected with the top ceiling, the connecting mechanism is arranged between the top plate and the mounting frame, and a top of the connecting mechanism is fixedly connected with the top plate, the connecting mechanism is rotatably connected with the rotating mechanism, and the rotating mechanism is capable of driving the mounting frame to rotate.

In some examples of the disclosure, the rotating mechanism includes a first motor and a first gear, the first motor is fixedly connected with the mounting frame, and the first gear is arranged on a first motor output shaft in a sleeving manner, the connecting mechanism includes a connecting shaft and a second gear, the second gear is arranged on the connecting shaft in a sleeving manner, the mounting frame is fixedly provided with a fixing plate, the first motor is arranged below the fixing plate, and the first motor output shaft penetrates the fixing plate so as to be fixedly connected with the first gear, the second gear is arranged above the fixing plate, and the connecting shaft penetrates the fixing plate so as to be fixedly connected with the second gear, the first gear is meshed with the second gear, the first motor drives the first gear to rotate around the second gear, so as to drive the mounting frame to rotate around the connecting shaft.

In some examples of the disclosure, a top surface and a bottom surface of the first gear respectively abut against a first bearing, the two first bearings are arranged on the first motor output shaft in a sleeving manner, a first bearing seat is arranged above the first bearing abutting against the top surface of the first gear, and the first bearing seat is fixedly connected with a top surface of the fixing plate, and/or, a bottom end of the connecting shaft is provided with a second bearing and a second bearing seat, the second bearing is arranged on the connecting shaft in a sleeving manner, and an inner ring of the second bearing is in interference fit with the connecting shaft, the second bearing seat is fixedly connected with a bottom surface of the fixing plate, and the second bearing is arranged in the second bearing seat.

In some examples of the disclosure, the connecting mechanism further includes a supporting sleeve and a plane thrust bearing, the supporting sleeve is arranged at a position of the connecting shaft penetrating the fixing plate in a sleeving manner and is in interference fit with the connecting shaft, the plane thrust bearing is arranged outside the supporting sleeve in a sleeving manner and is in interference fit with the supporting sleeve, a bottom of the second gear is provided with a cylindrical recess, a top surface of the plane thrust bearing abuts against an end surface of the cylindrical recess, and a bottom surface of the plane thrust bearing abuts against the top surface of the fixing plate, and/or, the connecting mechanism further includes a retainer, the retainer is arranged between the top plate and the second gear, and the top plate, the retainer and the second gear are connected with each other by a plurality of top plate fixing screws arranged in a circumferential direction, the retainer is connected with a top end surface of the connecting shaft by a connecting shaft fixing screw.

In some examples of the disclosure, the deployment and retraction mechanism further includes a fixed arm, a first end of the fixed arm is fixedly connected with the mounting frame, a second end of the fixed arm is hinged to an end of the movable arm away from the television mounting bracket.

In some examples of the disclosure, one of the fixed arm and the movable arm is provided with an arc-shaped groove, the other one of the fixed arm and the movable arm is provided with a fixing pin, in a rotation process of the movable arm, the fixing pin is able to move in the arc-shaped groove.

In some examples of the disclosure, the mounting frame includes a mounting seat and a top cover, the mounting seat is provided with a mounting recess, the top cover covers an opening of the mounting recess, and the fixing plate is arranged between the mounting seat and the top cover and is connected with at least one of the mounting seat and the top cover. The mounting recess is used to accommodate the first motor, a recess bottom of the mounting recess is provided with an avoidance hole, and an end of the electric push rod penetrates the avoidance hole so as to be hinged to two recess side walls of the mounting recess.

In the top mounting structure for a display device according to the examples of the disclosure, the rotating mechanism is rotatably connected with the top mounting bracket, such that the top mounting structure for the display device is able to adjust leftward and rightward rotation; and the telescopic part of the deployment and retraction mechanism drives the movable arm to rotate relative to the top mounting bracket, such that the movable arm is able to be opened or retracted relative to the top mounting bracket, and a left-right rotation angle and a pitch angle of the display device arranged on the movable arm is able to be adjusted. The top mounting structure for the display device has a function of multi-degree-of-freedom adjustment, and implements multi-angle and multi-range applications. Thus, a user is able to conveniently adjust the top mounting structure for the display device according to an angle of a position where the user is located.

Clearly, any product implementing the disclosure does not need to achieve all advantages mentioned above simultaneously.

### BRIEF DESCRIPTION OF THE DRAWINGS

In order to more clearly illustrate technical solutions in examples of the disclosure or in the prior art, the accompanying drawings required for the description of the examples or the prior art will be briefly introduced below. Obviously, the accompanying drawings in the following description are only some examples of the disclosure, and those of ordinary skill in the art would also be able to derive other drawings from these drawings.

FIG. 1 is a perspective structural diagram of a top mounting structure for a display device according to a first example of the disclosure at a first angle;

FIG. 2 is a perspective structural diagram of the top mounting structure for the display device shown in FIG. 1 at a second angle;

FIG. 3 is a perspective structural diagram of an deployment and retraction mechanism shown in FIG. 1 in a retracted state;

FIG. 4 is a first exploded schematic diagram of the top mounting structure for the display device shown in FIG. 1;

FIG. 5 is a second exploded schematic diagram of the top mounting structure for the display device shown in FIG. 1;

FIG. 6 is a cutaway view of the top mounting structure for the display device shown in FIG. 1;

FIG. 7 is an enlarged local view of a cutaway view of the top mounting structure for the display device shown in FIG. 6;

FIG. 8 is a local schematic structural diagram of the top mounting structure for the display device shown in FIG. 1;

FIG. 9 is a schematic structural diagram of a top mounting structure for the display device according to a second example of the disclosure in a first use state;

FIG. 10 is an exploded view of the top mounting structure for the display device according to the second example of the disclosure;

FIG. 11 is a schematic structural diagram of an annular mounting bracket according to the second example of the disclosure;

FIG. 12 is a cutaway view of the top mounting structure for the display device according to the second example of the disclosure at another angle;

FIG. 13 is an enlarged view of part A in FIG. 12;

FIG. 14 is a schematic local structural diagram of the top mounting structure for the display device according to the second example of the disclosure;

FIG. 15 is a schematic local structural diagram of the top mounting structure for the display device according to the second example of the disclosure;

FIG. 16 is a schematic local structural diagram of the top mounting structure for the display device according to the second example of the disclosure;

FIG. 17 is a schematic structural diagram of the top mounting structure for the display device according to the second example of the disclosure in a second use state;

FIG. 18 is a schematic structural diagram of a top mounting structure for the display device according to a third example of the disclosure;

FIG. 19 is an exploded view of the top mounting structure for the display device according to the third example of the disclosure;

FIG. 20 is an enlarged view of part A in FIG. 19;

FIG. 21 is a cutaway view of the top mounting structure for the display device according to the third example of the disclosure;

FIG. 22 is an enlarged view of part B in FIG. 21;

FIG. 23 is a schematic structural diagram of a top mounting structure for the display device according to a third example of the disclosure;

FIG. 24 is a cutaway view of the top mounting structure for the display device according to the third example of the disclosure;

FIG. 25 is an enlarged view of part C in FIG. 24;

FIG. 26 is a schematic structural diagram of a top mounting structure for the display device according to the disclosure at one angle;

FIG. 27 is a partial structural schematic diagram of the top mounting structure for the display device according to the third example of the disclosure;

FIG. 28 is a partial structural schematic diagram of the top mounting structure for the display device according to the third example of the disclosure;

FIG. 29 is a partial structural schematic diagram of the top mounting structure for the display device according to the third example of the disclosure; and

FIG. 30 is a partial structural schematic diagram of the top mounting structure for the display device according to the third example of the disclosure.

### DESCRIPTION OF REFERENCE NUMERALS

100, top mounting bracket; 110, top plate; 111, top plate fixing screw; 112, limiting member; 120, connecting mechanism; 121, connecting shaft; 1211, connecting shaft fixing screw; 1212, gasket; 122, second gear; 1221, cylindrical recess; 123, supporting sleeve; 124, plane thrust bearing; 125, retainer; 1251, stepped hole; 130, second bearing; 140, second bearing seat;
200, rotating mechanism; 210, first motor; 211, first motor output shaft; 220, first gear; 230, first bearing; 240, first bearing seat;
300, deployment and retraction mechanism; 310, electric push rod; 311, driving end; 312, movable end; 320, movable arm; 330, fixed arm; 340, arc-shaped groove; 350, fixing pin;
400, television mounting bracket; 410, supporting bracket; 420, hanging arm; 421, mounting hole;
500, mounting frame; 510, fixing plate; 520, top cover; 530, mounting seat; 531, mounting recess; 532, avoidance hole;
600, controller;
10, balancing mechanism; 11, guiding structure; 12, first balancing part; 13, guide recess; 14, rolling member; 15, annular mounting bracket; 151, inner ring; 152, outer ring; 153, reinforcing rib; 16, connecting hole; 17, rolling member mounting seat; 18, second balancing part; 20, connecting structure; 21, connecting seat; 2111, first through hole; 212, rotation limiting structure; 213, convex column; 214, semi-annular convex part; 22, anti-rotation plate; 221, anti-rotation hole; 222, notch; 1110, first top plate; 1111, fixing screw; 1112, second top plate; 201, limiting member; 202, second mounting seat; 203, first connector; 204, locking member; 205, rotating shaft; 206, top cover; 2061, fourth through hole; 207, bearing mounting seat; 208, deep groove ball bearing; 209, supporting sleeve; 2011, plane bearing; 2012, mounting plate; 30, second connector;
1101, top plate; 1201, connecting plate; 2001, first mounting seat; 2101, mounting plate; 2201, top seat; 31, driving motor; 32, transmission part; 321, driving gear; 322, transmission gear; 323, third mounting seat; 3231, mounting shaft; 3232, clamping slot; 324, first mounting frame; 325, nut; 326, gasket; 327, snap spring; 328, bolt; 33, fixing seat; 331, second through hole; 332, first annular recess; 34, second mounting seat; 341, first through hole; 342, mounting hole; 35, first rolling member; 36, second rolling member; 37, bearing seat; 38, rolling bearing; 40, connecting structure; 401, gear ring structure; 402, retaining ring; 4021, second annular recess; 403, mounting recess; 50, block; 60, protruding structure; 70, arc-shaped groove; 80, plane bearing; 90, second mounting frame; 2013, limiting protrusion; 2014, first limiting structure.

### Detailed Description of the Embodiments

Technical solutions in examples of the disclosure will be clearly and completely described below with reference to the accompanying drawings in the examples of the disclosure. Obviously, the described examples are merely some examples rather than all the examples of the disclosure. Based on the examples of the disclosure, all other examples obtained by those of ordinary skill in the art based on the disclosure should fall within the protection scope of the disclosure.

According to the background art, in the related art, a top mounting structure for a display device generally adjusts an angle manually or electrically, and is capable of only conducting open and retraction in a direction of a single degree of freedom. A user is only able to watch a television directly in front of the top mounting structure for the display device, instead of watching the television at other angles, thus failing to implement multi-angle and multi-range applications.

### Example 1

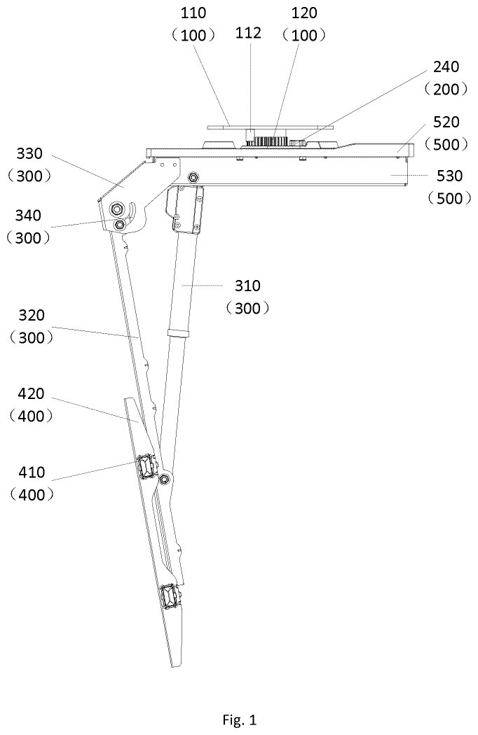

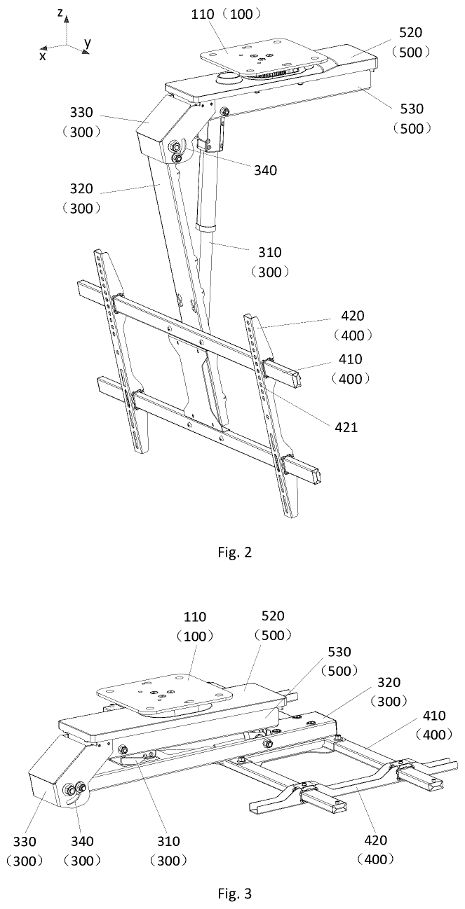

In view of this, Example 1 of the disclosure provides a top mounting structure for a display device. With reference to FIGS. 1-3, FIG. 1 is a perspective structural diagram of a top mounting structure for a display device according to Example 1 of the disclosure at a first angle; FIG. 2 is a perspective structural diagram of the top mounting structure for a display device shown in FIG. 1 at a second angle; and FIG. 3 is a perspective structural diagram of a deployment and retraction mechanism shown in FIG. 1 in a retracted state.

As shown in FIGS. 1-3, the top mounting structure for a display device according to Example 1 of the disclosure includes: a top mounting bracket 100 and a connecting assembly, the connecting assembly includes a rotating mechanism 200 and a deployment and retraction mechanism 300. The top mounting bracket 100 is used to be fixedly connected with a top ceiling. The rotating mechanism 200 is rotatably connected with the top mounting bracket 100. The deployment and retraction mechanism 300 is arranged below the rotating mechanism 200, and an upper portion of the deployment and retraction mechanism 300 is connected with the rotating mechanism 200. The deployment and retraction mechanism 300 includes a telescopic part and a movable arm 320 that are connected with each other. The telescopic part is capable of driving the movable arm 320 to rotate relative to the top mounting bracket 100, and the movable arm 320 is suitable for being directly or indirectly connected with the display device. In this way, a pitch angle of the display device relative to the top mounting bracket 100 is adjusted.

Specifically, the rotating mechanism 200 and the top mounting bracket 100 are arranged in a z-axis direction as shown in FIG. 2. The rotating mechanism 200 is capable of rotating relative to the top mounting bracket 100 around an axis in the Z-axis direction, such that a left-right rotation angle of the display device relative to the top mounting bracket 100 is adjusted.

A maximum open state of the deployment and retraction mechanism 300 is shown in FIGS. 1 and 2. The retracted state is shown in FIG. 3. The telescopic part may be an electric push rod, a gas spring, a pneumatic cylinder or a hydraulic cylinder device, etc. The telescopic part drives the movable arm 320 to open and retract relative to the top mounting bracket 100 by driving a movable end 312 to expand and contract. That is, the deployment and retraction mechanism 300 is capable of rotating around a y axis shown in FIG. 2 relative to the rotating mechanism 200, such that the pitch angle of the display device relative to the top mounting bracket 100 is adjusted.

The rotating mechanism 200 and the deployment and retraction mechanism 300 make the top mounting structure for the display device adjustable in two degrees of freedom, such that the top mounting structure for the display device conducts adjustment more flexibly, and an adjustment range is expanded.

The movable arm 320 is able to be provided with a video electronics standards association (VESA) hole, such that the display device is able to be directly connected with the movable arm 320 through the VESA hole, and the top mounting structure for the display device has a simpler structure.

In the top mounting structure for the display device according to the examples of the disclosure, the rotating mechanism 200 is rotatably connected with the top mounting bracket 100, such that the top mounting structure for the display device is able to adjust leftward and rightward rotation; and the telescopic part of the deployment and retraction mechanism 300 drives the movable arm 320 to rotate relative to the top mounting bracket 100, such that the movable arm 320 is able to be open or retracted relative to the top mounting bracket 100, and a left-right rotation angle and a pitch angle of the display device arranged on the movable arm 320 are able to be adjusted. The top mounting structure for the display device has a function of multi-degree-of-freedom adjustment, and implements multi-angle and multi-range applications. Thus, a user is able to conveniently adjust the top mounting structure for the display device according to an angle of a position where the user is located.

In some examples of the disclosure, as shown in FIGS. 1-3, the top mounting structure further includes a television mounting bracket 400. The television mounting bracket 400 is fixedly or rotatably connected with the movable arm 320. The television mounting bracket 400 is configured for mounting the display device.

Specifically, the television mounting bracket 400 includes a supporting bracket 410 and two hanging arms 420. The supporting bracket 410 is connected with the deployment and retraction mechanism 300, and the hanging arms 420 are hung on the supporting bracket 410 and slidably connected with the supporting bracket 410. The hanging arms 420 are provided with a plurality of mounting holes 421 used to mount the display device. The television mounting bracket 400 is able to be further provided with a VESA board used to mount a display.

The display device is indirectly connected with the movable arm 320 by the television mounting bracket 400, and the television mounting bracket 400 is fixedly connected with the movable arm 320, such that the pitch angle of the display device is able to be adjusted under the drive of the movable arm 320. Alternatively, the television mounting bracket 400 is rotatably connected with the movable arm 320, such that the pitch angle of the display device is able to be adjusted. Moreover, the display device is able to be adjusted to rotate leftward and rightward based on a rotating joint. Further, the top mounting structure for the display device conducts adjustment more flexibly, and an adjustment range is expanded.

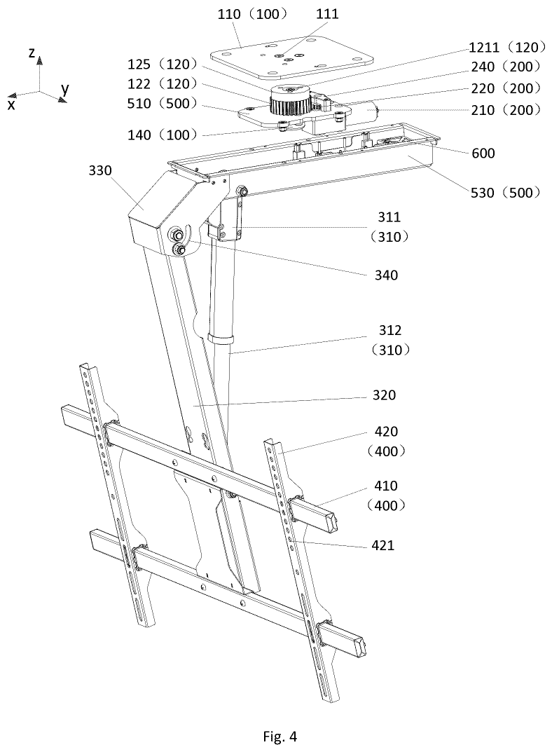

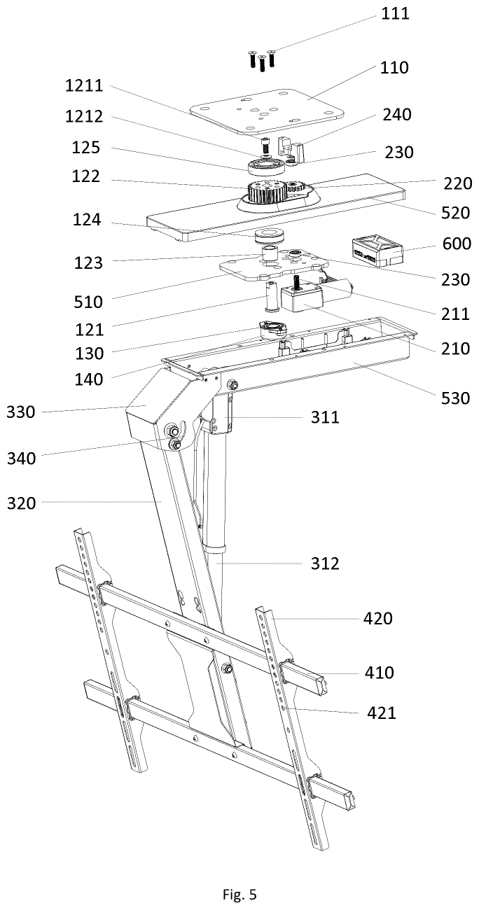

In some examples of the disclosure, with reference to FIGS. 4 and 5, FIG. 4 is a first exploded schematic diagram of the top mounting structure for the display device shown in FIG. 1; and FIG. 5 is a second exploded schematic diagram of the top mounting structure for the display device shown in FIG. 1.

As shown in FIGS. 4 and 5, the top mounting structure for the display device further includes a mounting frame 500. The rotating mechanism 200 is fixedly arranged on the mounting frame 500. The telescopic part is an electric push rod 310. A first end of the electric push rod 310 is hinged to the mounting frame 500, and a second end of the electric push rod 310 is hinged to the movable arm 320. The electric push rod 310 extends and shortens to adjust an included angle between the movable arm 320 and the mounting frame 500.

The deployment and retraction mechanism 300 further includes a fixed arm 330. A first end of the fixed arm 330 is fixedly connected with the mounting frame 500. A second end of the fixed arm 330 is hinged to an end of the movable arm 320 away from the television mounting bracket 400.

Specifically, the mounting frame 500 includes a mounting seat 530 and a top cover 520, and the electric push rod 310, the movable arm 320 and the fixed arm 330 are arranged at a same end of a bottom of the mounting seat 530. The electric push rod 310 includes a driving end 311 and a movable end 312, the driving end 311 is a driving motor and is hinged to the bottom of the mounting seat 530, the movable end 312 is hinged to a bottom end of the movable arm 320, and a top end of the movable arm 320 is hinged to a bottom end of the fixed arm 330.

When the driving end 311 drives the movable end 312 to expand, the electric push rod 310 and the movable arm 320 rotate away from the mounting frame 500 based on hinge parts of top ends of the electric push rod and the movable arm respectively, that is, open relative to the mounting frame 500. When the movable end 312 is driven to contract, the electric push rod 310 and the movable arm 320 rotate close to the mounting frame 500 based on hinge parts of the top ends of the electric push rod and the movable arm respectively, and is able to rotate to a position parallel to the mounting frame 500 as shown in FIG. 3, such that a top electric support is accommodated.

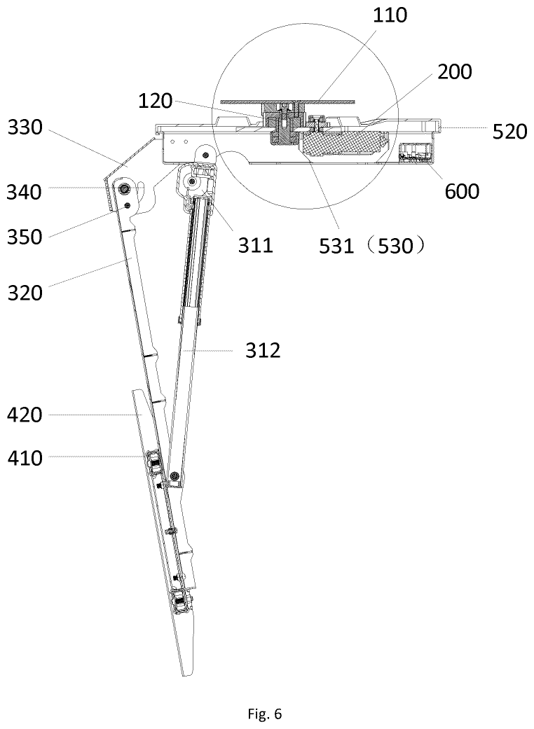

In some examples of the disclosure, with reference to FIG. 6, FIG. 6 is a sectional view of the top mounting structure for the display device shown in FIG. 1. As shown in FIGS. 4-6, one of the fixed arm 330 and the movable arm 320 is provided with an arc-shaped groove 340, and the other one of the fixed arm 330 and the movable arm 320 is provided with a fixing pin 350. In a rotation process of the movable arm 320, the fixing pin 350 is able to move in the arc-shaped groove 340.

Specifically, the arc-shaped groove 340 is provided below a hinge part of the fixed arm 330 and the movable arm 320, and the fixing pin 350 is arranged on the movable arm 320. In an open and retraction process of the movable arm 320, the fixing pin 350 is able to move in the arc-shaped groove 340.

The fixed arm 330 is an inverted U-shaped member, and an included angle between the fixed arm 330 and the mounting frame 500 is obtuse, such that stability of the deployment and retraction mechanism 300 is improved. The arc-shaped groove 340 limits a rotation stroke of the movable arm 320, and two ends of the arc-shaped groove 340 have stronger torsion resistance. In this way, forward swinging of the movable arm 320 caused by failure of the electric push rod 310 is avoided, and security of the movable arm 320 in a rotation process is improved.

In some examples of the disclosure, as shown in FIGS. 4-6, the top mounting bracket 100 includes: a top plate 110 and a connecting mechanism 120. The top plate 110 is used to be fixedly connected with the top ceiling. The connecting mechanism 120 is arranged between the top plate 110 and the mounting frame 500, and a top of the connecting mechanism 120 is fixedly connected with the top plate 110. The connecting mechanism 120 is rotatably connected with the rotating mechanism 200, and the rotating mechanism 200 is capable of driving the mounting frame 500 to rotate.

Specifically, an edge of the top plate 110 is provided with a plurality of through holes, and each of the through holes is connected with the top ceiling through a threaded fastener. The top plate 110 increases a contact area between the top mounting bracket 100 and the ceiling, and improves mounting stability of the top mounting structure for the display device.

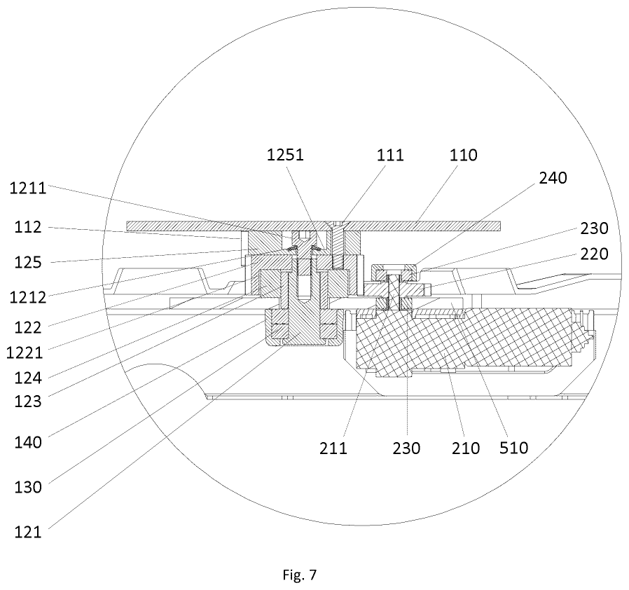

In some examples of the disclosure, with reference to FIG. 7, FIG. 7 is a partially enlarged view of the sectional view of the top mounting structure for the display device shown in FIG. 6. As shown in FIGS. 5-7, the rotating mechanism 200 includes a first motor 210 and a first gear 220. The first motor 210 is fixedly connected with the mounting frame 500, and the first gear 220 is arranged on a first motor output shaft 211 in a sleeving manner. The connecting mechanism 120 includes a connecting shaft 121 and a second gear 122. The second gear 122 is arranged on the connecting shaft 121 in a sleeving manner. The mounting frame 500 is fixedly provided with a fixing plate 510, the first motor 210 is arranged below the fixing plate 510, and the first motor output shaft 211 penetrates the fixing plate 510 so as to be fixedly connected with the first gear 220. The second gear 122 is arranged above the fixing plate 510, and the connecting shaft 121 penetrates the fixing plate 510 so as to be fixedly connected with the second gear 122. The first gear 220 is meshed with the second gear 122. The first motor 210 drives the first gear 220 to rotate around the second gear 122, so as to drive the mounting frame 500 to rotate around the connecting shaft 121.

Specifically, as shown in FIG. 5, a top section of the connecting shaft 121 is non-circular, and a shape and a size of an inner hole of the second gear 122 matched with the connecting shaft 121 are consistent with those of the top section of the connecting shaft 121. By applying the example of the disclosure, rotation of the rotating mechanism 200 is implemented by gear transmission, such that transmission efficiency and service life of the rotating mechanism 200 are improved, and the top mounting structure for the display device has a more compact structure.

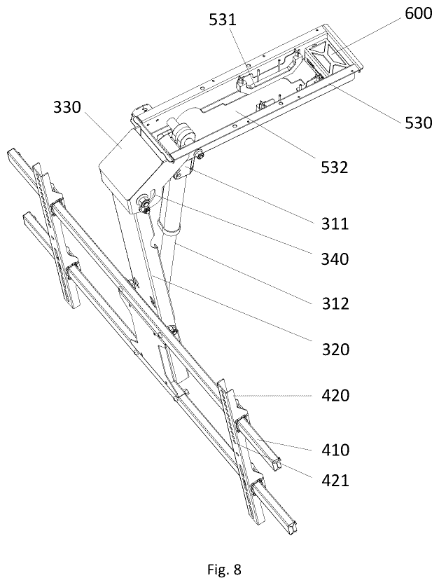

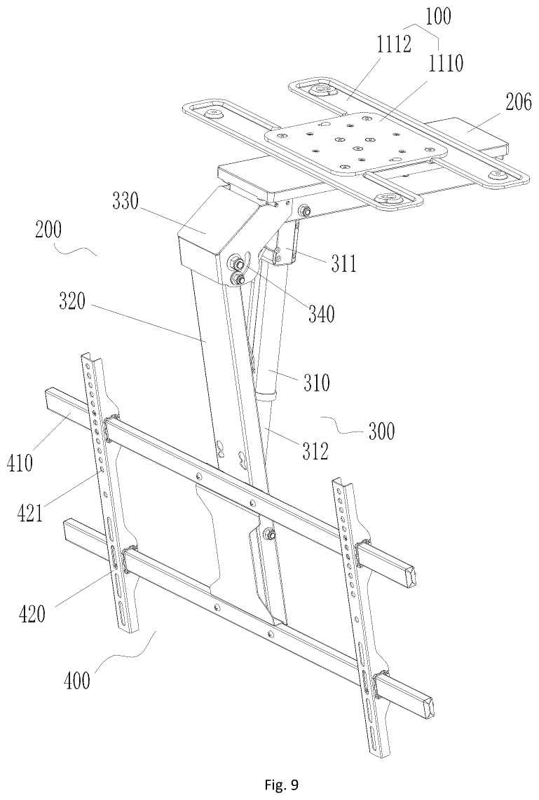

In some examples of the disclosure, with reference to FIG. 8, FIG. 8 is a local schematic structural diagram of the top mounting structure for the display device shown in FIG. 1. As shown in FIGS. 6 and 8, the mounting frame 500 includes a mounting seat 530 and a top cover 520. The mounting seat 530 is provided with a mounting recess 531, the top cover 520 covers an opening of the mounting recess 531, and the fixing plate 510 is arranged between the mounting seat 530 and the top cover 520 and is connected with at least one of the mounting seat 530 and the top cover 520. The mounting recess 531 is used to accommodate the first motor 210, a recess bottom of the mounting recess 531 is provided with an avoidance hole 532, and an end of the electric push rod 310 penetrates the avoidance hole 532 so as to be hinged to two recess side walls of the mounting recess 531.

Specifically, the fixing plate 510 is fixedly connected with the mounting seat 530 or the top cover 520. When the first motor 210 drives the first gear 220 to rotate around the second gear 122, the mounting frame 500 and the fixing plate 510 are driven to rotate around the connecting shaft 121. The bottom of the mounting recess 531 is provided with an avoidance hole 532 whose contour is matched with that of the electric push rod 310. When the electric push rod 310 contracts, the electric push rod 310 rotates to be accommodated in the mounting seat 530 based on a hinge part to the recess side walls, such that an accommodated structure of the top mounting structure for the display device of the example of the disclosure is more compact and saves space.

In some examples of the disclosure, as shown in FIGS. 5-7, a top surface and a bottom surface of the first gear 220 each abut against a first bearing 230, the two first bearings 230 are arranged on the first motor output shaft 211 in a sleeving manner, a first bearing seat 240 is arranged above the first bearing 230 abutting against the top surface of the first gear 220, and the first bearing seat 240 is fixedly connected with a top surface of the fixing plate 510. And/or, a bottom end of the connecting shaft 121 is provided with a second bearing 130 and a second bearing seat 140. The second bearing 130 is arranged on the connecting shaft 121 in a sleeving manner, and an inner ring of the second bearing 130 is in interference fit with the connecting shaft 121. The second bearing seat 140 is fixedly connected with a bottom surface of the fixing plate 510, and the second bearing 130 is arranged in the second bearing seat 140.

Specifically, a plurality of second bearings 130 are provided. In the example of the disclosure, two second bearings 130 are provided, and the two second bearings 130 are sequentially arranged in the second bearing seat 140. The first bearing 230 and the second bearings 130 are rolling bearings used to bear radial load and reduce friction, such that gear transmission efficiency is improved. When the first motor 210 drives the first gear 220 to rotate around the second gear 122, the fixing plate 510 fixedly connected with the first bearing seat 240 and the mounting frame 500 fixedly connected with the fixing plate 510 are driven to rotate, such that the display device connected with the mounting frame 500 through the deployment and retraction mechanism 300 is rotated.

As shown in FIGS. 1 and 7, two limiting members 112 are fixed to a bottom surface of the top plate 110, and are arranged at two sides of the connecting mechanism 120. When the first gear 220 rotates around the second gear 122, the first bearing seat 240 at a top of the rotating mechanism 200 is limited, such that a maximum rotation angle of the rotating mechanism 200 is limited.

By applying the example of the disclosure, the first bearing 230 and the second bearings 130 are able to bear radial load and reduce friction caused by rotation, such that gear transmission efficiency is improved.

In some examples of the disclosure, as shown in FIGS. 5-7, the connecting mechanism 120 further includes a supporting sleeve 123 and a plane thrust bearing 124. The supporting sleeve 123 is arranged at a position of the connecting shaft 121 penetrating the fixing plate 510 in a sleeving manner and is in interference fit with the connecting shaft 121. The plane thrust bearing 124 is arranged outside the supporting sleeve 123 in a sleeving manner and is in interference fit with the supporting sleeve 123. A bottom of the second gear 122 is provided with a cylindrical recess 1221, a top surface of the plane thrust bearing 124 abuts against an end surface of the cylindrical recess 1221, and a bottom surface of the plane thrust bearing abuts against the top surface of the fixing plate 510. And/or, the connecting mechanism 120 further includes a retainer 125. The retainer 125 is arranged between the top plate 110 and the second gear 122, and the top plate 110, the retainer 125 and the second gear 122 are connected with each other by a plurality of top plate 110 fixing screws 111 arranged in a circumferential direction. The retainer 125 is connected with a top end surface of the connecting shaft 121 by a connecting shaft fixing screw 1211.

Specifically, as shown in FIG. 7, the cylindrical recess 1221 of the second gear 122 accommodates the plane thrust bearing 124 and the retainer 125, such that the connecting structure is more compact. A center of the retainer 125 is provided with a stepped hole 1251. The connecting shaft fixing screw 1211 penetrates the stepped hole 1251 so as to be connected with the connecting shaft 121 in a threaded manner. A gasket 1212 is arranged between the connecting shaft fixing screw 1211 and an inner plane of the stepped hole 1251, so as to prevent the connecting shaft fixing screw 1211 from being loosened. By applying the example of the disclosure, the supporting sleeve 123 is able to be arranged to reduce swinging of the connecting shaft 121, such that wear of the second bearings 130 and the connecting shaft 121 is avoided, service life of the second bearings 130 is prolonged, and occurrence of mechanical failures is reduced. The plane thrust bearing 124 is used to bear axial load and play a damping role, such that wear of the second gear 122 and the connecting shaft 121 is reduced, and service life of the second gear 122 and the connecting shaft 121 is prolonged. The retainer 125 is able to be arranged to enable the connecting mechanism 120 and the top plate 110 to be connected more stably, and reduce wear of the second gear 122.

In some examples of the disclosure, as shown in FIGS. 5, 6 and 8, the top mounting structure for the display device further includes: a controller 600. The controller 600 is arranged on a base and is in communication connection with the rotating mechanism 200 and the deployment and retraction mechanism 300, so as to control the rotating mechanism 200 to rotate around the top mounting bracket 100 and control the deployment and retraction mechanism 300 to open and retract relative to the top mounting bracket 100.

Specifically, the controller 600 is provided with a plurality of interfaces that are used to be connected with the driving end 311 of the electric push rod 310 and the first motor 210 respectively. The driving end 311 of the electric push rod 310 and the first motor 210 are provided with sensors, such that position signals of the movable end 312 of the electric push rod 310 and the rotating mechanism 200 are able to be fed back to the controller 600. The user is able to transmit an instruction signal to the controller 600 by a remote controller, and the controller 600 receives the signal and transmits control instructions to the driving end 311 of the electric push rod 310 and the first motor 210 according to the position signals fed back by the sensors, such that deployment and retraction of the electric push rod 310 and rotation of the rotating mechanism 200 are controlled, and the top mounting structure for the display device adjusts the display device to a specified angle.

The controller 600 further has a memory reset function. When the top mounting structure for the display device of the example of the disclosure is used initially, in response to determining that the rotating mechanism 200 rotates until the first bearing seat 240 abuts against a limiting member 112, the sensor on the first motor 210 feeds back position information to the controller 600, and the controller 600 records the position as an initial position. The rotating mechanism 200 is prevented from hitting the limiting member 112 in subsequent use. By applying the example of the disclosure, the controller 600 is arranged, such that control accuracy and security of the rotating mechanism 200 in a rotation process are improved.

### Example 2

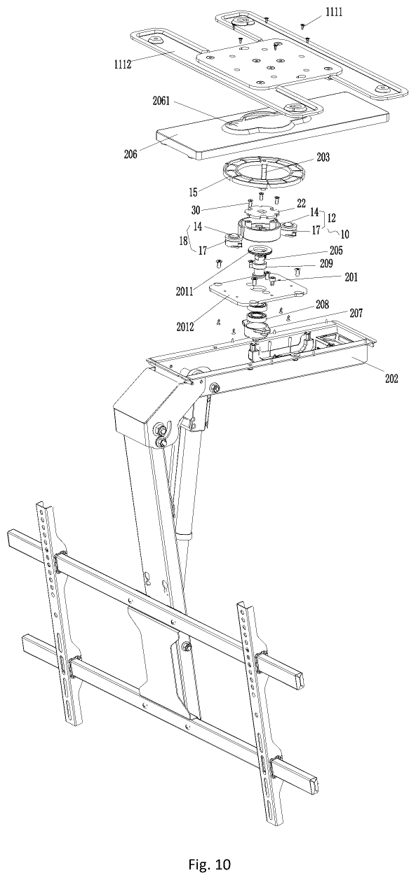

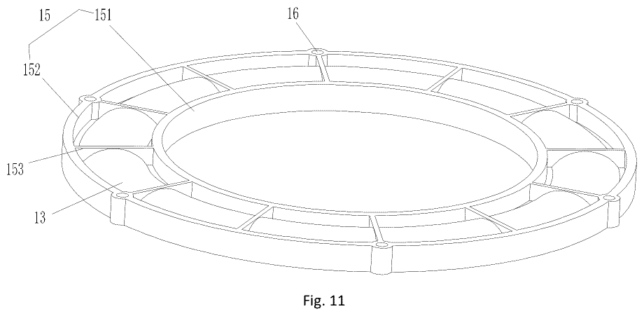

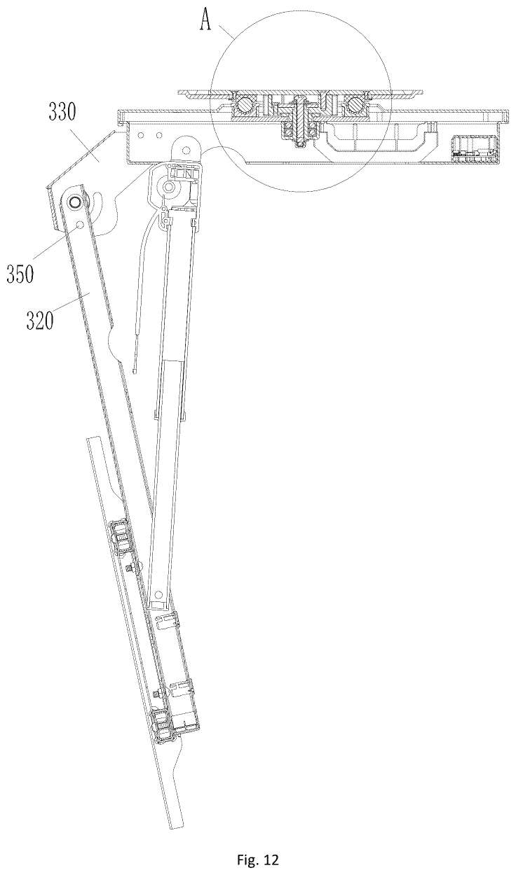

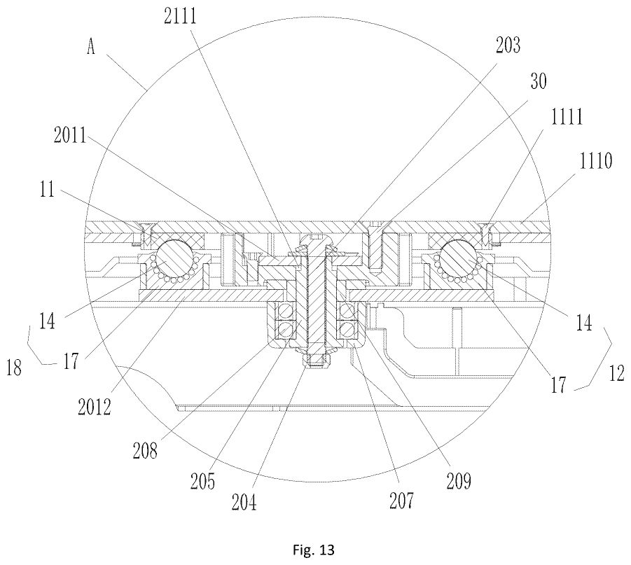

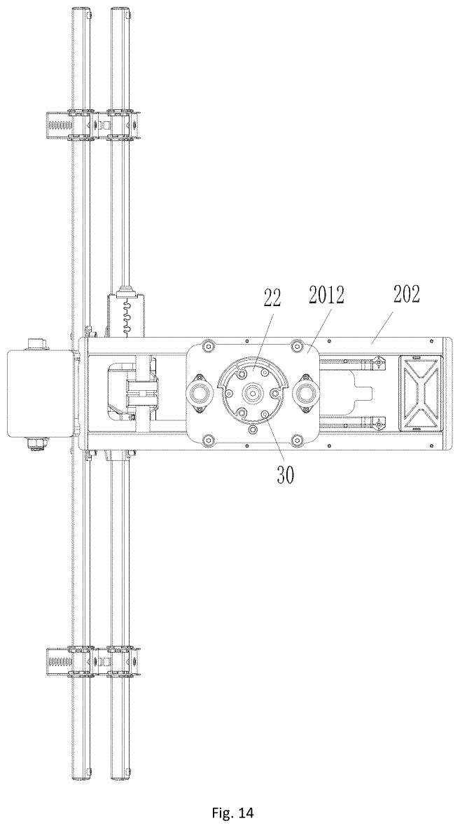

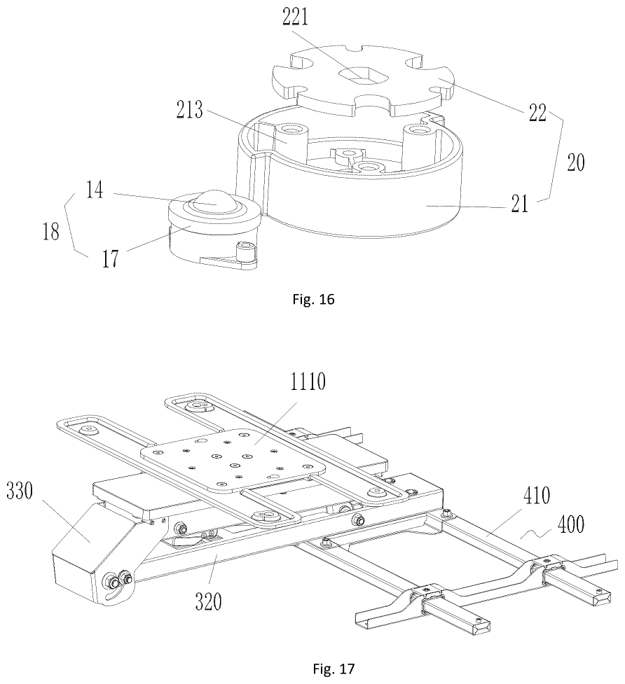

Example 2 of the disclosure provides a top mounting structure for a display device. With reference to FIGS. 9-16, the disclosure provides the top mounting structure for the display device. The top mounting structure for the display device includes: a top mounting bracket 100; a connecting assembly rotatably connected with the top mounting bracket 100, where the connecting assembly is used to be connected with the display device; and a balancing mechanism 10 including a first balancing part 12. The first balancing part 12 is connected with the connecting assembly, the first balancing part 12 is configured to abut against the top mounting bracket 100, and an abutting position of the first balancing part 12 and the top mounting bracket 100 is a first position. When the top mounting structure for the display device is in a first use state, a center of gravity of the connecting assembly on which the display device is mounted is a first center of gravity. The first position and the first center of gravity are located at two sides of a rotating axis in a radial direction of the rotating axis of the connecting assembly.

In the example, the top mounting bracket 100 is fixedly connected with a ceiling, the connecting assembly is rotatably connected with the top mounting bracket 100, and the connecting assembly is used to be connected with the display device (for instance, a television). During use, a user may rotate the connecting assembly relative to the top mounting bracket 100 manually or by other tools, such that the connecting assembly drives the display device to rotate, and adjustment of an angle of the display device is implemented. FIG. 9 shows the first use state of the top mounting structure for the display device. The user may view contents on the display device in the first use state.

The connecting assembly includes a rotating mechanism 200. The connecting assembly is rotatably connected with the top mounting bracket 100 by the rotating mechanism 200.

The balancing mechanism 10 is connected with the connecting assembly and is capable of rotating with the connecting assembly relative to the top mounting bracket 100. When the display device is connected with the connecting assembly, the connecting assembly and the display device constitute a new whole, and a center of gravity of the new whole is the first center of gravity. The first center of gravity is not collinear with the rotating axis of the connecting assembly in a vertical direction, such that the connecting assembly on which the display device is mounted tends to tilt to a side where the display device is located relative to the top mounting bracket 100. That is, a side of the connecting assembly tends to tilt up. The disclosure is provided with the balancing mechanism 10, and the first position and the first center of gravity are located at two sides of the rotating axis. That is, an acting force point of an abutting force between the first balancing part 12 and the top mounting bracket 100 and the first center of gravity are located at the two sides of the rotating axis. After the display device is connected with the connecting assembly, a side, tending to tilt up, of the connecting assembly fails to tilt up under the abutting force between the first balancing part 12 and the top mounting bracket 100, such that a rotation process of the connecting assembly is relatively stable. From the above description, it can be seen that, by the arrangement, tilting of the connecting assembly is able to be avoided, stability of the entire structure is able to be ensured, and service life of the mounting structure is able to be prolonged. Meanwhile, appearance of the entire structure is able to be improved, and user experience is able to be enhanced.

In one example of the disclosure, an abutting surface of the first balancing part 12 with the top mounting bracket 100 is an arc-shaped convex surface.

By the arrangement, materials are able to be saved and production cost is able to be reduced on the premise of ensuring that the first balancing part 12 abuts against the top mounting bracket 100.

In one example, a bottom surface of the top mounting bracket 100 is provided with a recess matched with the arc-shaped convex surface, such that a contact area between the top mounting bracket and the arc-shaped convex surface is able to be expanded, and abutting stability between the top mounting bracket and the arc-shaped convex surface is able to be improved.

With reference to FIGS. 9-16, the first balancing part 12 includes a rolling member 14, and the rolling member 14 is able to roll relative to the top mounting bracket 100.

In the example, the rolling member 14 abuts against the top mounting bracket 100 and is able to roll relative to the top mounting bracket 100. When the connecting assembly rotates relative to the top mounting bracket 100, rolling friction exists between the first balancing part 12 and the top mounting bracket 100. The rolling friction has smaller friction than sliding friction. Thus, by the arrangement, on the premise of avoiding tilting of a rotating body, a rotation process of the connecting assembly is able to be ensured to be smoother, and user experience is able to be improved.

With reference to FIGS. 9-16, in one example of the disclosure, when the first balancing part 12 includes the rolling member 14, the top mounting bracket 100 includes a guiding structure 11, the guiding structure 11 includes a guide groove 13, and the rolling member 14 is arranged in the guide groove 13 in a rolling manner.

By the arrangement, the rolling member 14 is able to be guided.

In one example, the rolling member 14 is a steel ball, an iron ball, etc.

With reference to FIGS. 9-16, in one example of the disclosure, the guiding structure 11 further includes an annular mounting bracket 15, the guide groove 13 is provided on the annular mounting bracket 15, and the annular mounting bracket 15 is detachably connected with the top mounting bracket 100.

In the example, the guide groove 13 is provided on a bottom of the annular mounting bracket 15. After long-term use, the guide groove 13 may be worn or damaged. The annular mounting bracket 15 is detachably connected with the top mounting bracket 100, such that the annular mounting bracket 15 is able to be replaced and maintained independently, and the entire mounting structure does not need to be replaced.

With reference to FIGS. 9-16, in one example of the disclosure, the annular mounting bracket 15 includes an inner ring 151, an outer ring 152, and a plurality of reinforcing ribs 153, the guide groove 13 is annular, the guide groove 13 is provided between the inner ring 151 and the outer ring 152, the plurality of reinforcing ribs 153 are arranged at intervals in a circumferential direction of the annular mounting bracket 15, and the reinforcing ribs 153 are connected between the inner ring 151 and the outer ring 152 and are capable of supporting the guide groove 13.

In the example, the guide groove 13 is annular, such that the rolling member 14 is able to be guided in the circumferential direction of the annular mounting bracket 15. By the arrangement of the plurality of reinforcing ribs 153, structural strength of the annular mounting bracket 15 is able to be improved, and further the guide groove 13 is able to be supported. In this way, a probability of damaging the guide groove 13 in an abutting process between the rolling member 14 and the guide groove 13 is reduced, and service life of the annular mounting bracket 15 is prolonged.

With reference to FIGS. 9-16, in one example of the disclosure, when the first balancing part 12 includes the rolling member 14, the first balancing part 12 further includes a rolling member mounting seat 17, the rolling member mounting seat 17 is connected with the connecting assembly, the rolling member 14 is spherical, and the rolling member 14 is mounted on the rolling member mounting seat 17.

In the example, the rolling member mounting seat 17 is connected with the connecting assembly and is capable of rotating with the connecting assembly relative to the top mounting bracket 100. The rolling member 14 is mounted on the rolling member mounting seat 17 and is capable of rotating at any angle relative to the rolling member mounting seat 17. By the arrangement, the rolling member 14 is able to be mounted.

With reference to FIGS. 9-17, in one example of the disclosure, the balancing mechanism 10 further includes a second balancing part 18, the first balancing part 12 and the second balancing part 18 are symmetrically arranged with respect to the rotating axis, the second balancing part 18 abuts against the top mounting bracket 100, and an abutting position of the second balancing part 18 and the top mounting bracket 100 is a second position. When an deployment and retraction mechanism 300 is in a second use state, a center of gravity of the connecting assembly on which the display device is mounted is a second center of gravity, and the second position and the second center of gravity are located at two sides of the rotating axis in the radial direction of the rotating axis of the connecting assembly.

In the example, FIG. 17 shows the second use state of the top mounting structure for the display device. In this case, the connecting assembly is turned up to a position parallel to the top mounting bracket 100. When the top mounting structure for the display device is in the second use state, the second position and the second center of gravity are located at two sides of the rotating axis. That is, an acting force point of an abutting force between the second balancing part 18 and the top mounting bracket 100 and the second center of gravity are located at the two sides of the rotating axis. The second center of gravity is not collinear with the rotating axis of the connecting assembly in the vertical direction, such that the connecting assembly on which the display device is mounted tends to tilt to a side where the display device is located relative to the top mounting bracket 100. That is, a side of the connecting assembly tends to tilt up. The disclosure is provided with the second balancing part 18. After the display device is connected with the connecting assembly, a side, tending to tilt up, of the connecting assembly fails to tilt up under the abutting force between the second balancing part 18 and the top mounting bracket 100, such that the connecting assembly is prevented from tilting.

With reference to FIGS. 9-16, in one example of the disclosure, the second balancing part 18 includes the rolling member 14 and the rolling member mounting seat 17, the rolling member mounting seat 17 is connected with the connecting assembly, the rolling member 14 is spherical, the rolling member 14 is mounted on the rolling member mounting seat 17, and the rolling member 14 abuts against the top mounting bracket 100.

With reference to FIGS. 9-16, in one example of the disclosure, the connecting assembly further includes the deployment and retraction mechanism 300 and a second mounting seat 202. The second mounting seat 202 is rotatably connected with the top mounting bracket 100 by the rotating mechanism 200. The deployment and retraction mechanism 300 has a deployed position and a retracted position. The deployment and retraction mechanism 300 includes a telescopic part and a movable arm 320 connected with each other. The movable arm 320 is rotatably connected with the second mounting seat 202, the movable arm 320 is used to be connected with the display device, and the telescopic part is capable of driving the movable arm 320 to rotate relative to the second mounting seat 202, such that the deployment and retraction mechanism 300 is switched between the deployed position and the retracted position. When the deployment and retraction mechanism 300 is at the deployed position, the top mounting structure for the display device is in the first use state. When the deployment and retraction mechanism 300 is at the retracted position, the top mounting structure for the display device is in the second use state.

In the example, the connecting assembly is capable of rotating around a vertical axis (that is, a rotating axis extending in the vertical direction in FIG. 9). FIG. 9 shows that the deployment and retraction mechanism 300 is at the deployed position. The movable arm 320 is almost perpendicular to the second mounting seat 202. FIG. 17 shows that the deployment and retraction mechanism 300 is at the retracted position. The movable arm 320 is parallel to a bottom of the second mounting seat 202.

Specifically, the deployment and retraction mechanism 300 further includes a television mounting bracket 400. The television mounting bracket 400 is fixedly connected with the movable arm 320. The television mounting bracket 400 includes a supporting bracket 410 and two hanging arms 420. The supporting bracket 410 is connected with the movable arm 320. The two hanging arms 420 are hung on the supporting bracket 410. The two hanging arms 420 are both provided with a plurality of mounting holes 421 used to mount the display device. The telescopic part is an electric push rod 310. A first end of the electric push rod 310 is hinged to the second mounting seat 202, and a second end of the electric push rod 310 is hinged to the movable arm 320. The electric push rod 310 extends or shortens to adjust an included angle between the movable arm 320 and the second mounting seat 202.

The deployment and retraction mechanism 300 further includes a fixed arm 330. A first end of the fixed arm 330 is fixedly connected with the second mounting seat 202. A second end of the fixed arm 330 is hinged to an end of the movable arm 320 away from the television mounting bracket 400. The electric push rod 310 includes a driving end 311 and a movable end 312. The driving end 311 is a driving motor and is hinged to the bottom of the second mounting seat 202. The movable end 312 is hinged to a bottom end of the movable arm 320. A top end of the movable arm 320 is hinged to a bottom end of the fixed arm 330. When the driving end 311 drives the movable end 312 to expand, the electric push rod 310 and the movable arm 320 rotate away from the second mounting seat 202 based on hinge parts of top ends of the electric push rod and the movable arm respectively, that is, open relative to the second mounting seat 202. When the movable end 312 is driven to contract, the electric push rod 310 and the movable arm 320 rotate close to the second mounting seat 202 based on hinge parts of the top ends of the electric push rod and the movable arm respectively, and is able to rotate to a position parallel to the bottom of the second mounting seat 202 as shown in FIG. 17, such that the electric push rod and the movable arm is able to be accommodated.

With reference to FIGS. 9-16, in one example, one of the fixed arm 330 and the movable arm 320 is provided with an arc-shaped groove 340, and the other one of the fixed arm 330 and the movable arm 320 is provided with a fixing pin 350. In a rotation process of the movable arm 320, the fixing pin 350 is able to move in the arc-shaped groove 340. The arc-shaped groove 340 limits a rotation stroke of the movable arm 320, such that security of the movable arm 320 in the rotation process is improved.

With reference to FIGS. 9-16, in one example of the disclosure, the top mounting structure for the display device further includes a connecting structure 20, the connecting structure 20 is fixedly connected with the top mounting bracket 100, and the connecting assembly is rotatably connected with the connecting structure 20.

By the arrangement, the connecting assembly is able to be rotatably connected with the top mounting bracket 100.

With reference to FIGS. 9-16, in one example of the disclosure, the connecting structure 20 includes a connecting seat 21, the connecting seat 21 is fixedly connected with the top mounting bracket 100, the connecting seat 21 is provided with at least one rotation limiting structure 212, the connecting assembly further includes a limiting member 201, and the limiting member 201 is in retaining fit with the rotation limiting structure 212 in a circumferential direction of the connecting seat 21.

By the arrangement, the connecting assembly is able to be rotated by a preset angle relative to the top mounting bracket 100.

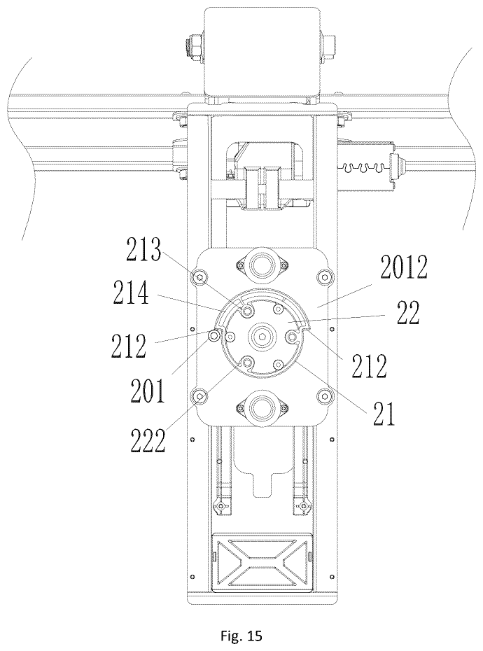

As shown in FIG. 15, in one example, the limiting member 201 is a screw, a periphery of the connecting seat 21 is provided with a semi-annular convex part 214, and two end surfaces of the semi-annular convex part 214 are provided with two rotation limiting structures 212. When the limiting member 201 rotates with the connecting assembly to a position where the two end surfaces are located, the two end surfaces are able to stop the limiting member 201, such that the connecting assembly is limited in the circumferential direction.

With reference to FIGS. 9-16, in one example of the disclosure, the connecting structure 20 further includes an anti-rotation plate 22, the connecting seat 21 is provided with a mounting cavity, the anti-rotation plate 22 is mounted in the mounting cavity, and the anti-rotation plate 22 and the connecting seat 21 are limited in the circumferential direction of the connecting seat 21.

Through the arrangement, the anti-rotation plate 22 is able to be mounted.

As shown in FIG. 15, in one example, an inner wall of the mounting cavity is provided with a plurality of convex columns 213, the plurality of convex columns 213 are arranged at intervals in a circumferential direction of the mounting cavity, the anti-rotation plate 22 is provided with a plurality of notches 222, the plurality of notches 222 are arranged in one-to-one correspondence to the plurality of convex columns 213, and the convex columns 213 are clamped in the corresponding notches 222. By arrangement of the convex columns 213, the anti-rotation plate 22 fails to rotate relative to the connecting seat 21.

With reference to FIGS. 9-16, in one example of the disclosure, the connecting assembly further includes a rotating shaft 205 and the second mounting seat 202. The anti-rotation plate 22 is provided with an anti-rotation hole 221. The connecting seat 21 is further provided with a first through hole 2111. The anti-rotation hole 221 is provided corresponding to the first through hole 2111. The top mounting structure for the display device further includes a first connector 203. A first end of the rotating shaft 205 penetrates the first through hole 2111 and the anti-rotation hole 221 sequentially, and forms rotation-stopping fit with the anti-rotation hole 221. In addition, the first end of the rotating shaft 205 is connected with the connecting seat 21 by the first connector 203, and a second end of the rotating shaft 205 is rotatably connected with the second mounting seat 202.

By the arrangement, the second mounting seat 202 is able to be rotatably connected with the top mounting bracket 100.

With reference to FIGS. 9-16, in one example of the disclosure, the connecting assembly further includes a mounting plate 2012, a bearing mounting seat 207, two deep groove ball bearings 208, a supporting sleeve 209, a locking member 204, and a plane bearing 2011. The rotating shaft 205 is provided with a second through hole penetrating the rotating shaft 205. The anti-rotation plate 22 is provided with the anti-rotation hole 221. The connecting seat 21 is provided with the first through hole 2111. The mounting plate 2012 is provided with a third through hole, and the third through hole is provided corresponding to the first through hole 2111. The mounting plate 2012 is fixedly mounted on the second mounting seat 202. The bearing mounting seat 207 is fixedly mounted on a bottom of the mounting plate 2012. The bearing mounting seat 207 is provided with an inner cavity. The two deep groove ball bearings 208 are sequentially arranged in the inner cavity of the bearing mounting seat 207 in a vertical direction. A first end of the rotating shaft 205 sequentially penetrates the first through hole 2111 and the anti-rotation hole 221, and is in anti-rotation fit with the anti-rotation hole 221. A second end of the rotating shaft 205 penetrates the inner cavity of the bearing mounting seat 207 after penetrating the third through hole. The two deep groove ball bearings 208 and the supporting sleeve 209 are all arranged on the rotating shaft 205 in a sleeving manner. The supporting sleeve 209 and the two deep groove ball bearings 208 are stacked sequentially from top to bottom. A top of the supporting sleeve 209 abuts against a bottom of the connecting seat 21. The plane bearing 2011 is arranged on the supporting sleeve 209 in a sleeving manner. A top surface of the plane bearing 2011 is attached to a bottom of the supporting sleeve 209. A bottom surface of the plane bearing 2011 is attached to the mounting plate 2012. A first end of the first connector 203 penetrates the mounting cavity of the connecting seat 21 and then is connected with the connecting seat 21, and a second end of the first connector 203 is in locking fit with the locking member 204 after penetrating the second through hole.

In one example, the first connector 203 is a bolt, and the locking member 204 is a nut.

With reference to FIGS. 9-16, in one example of the disclosure, the connecting assembly further includes a top cover 206, the top cover 206 covers the second mounting seat 202, and the top cover 206 is provided with a fourth through hole 2061. By the arrangement of the fourth through hole 2061, the rolling member 14 is able to be exposed out of the inner cavity of the second mounting seat 202 so as to be in guiding fit with the guide groove 13 on the annular mounting bracket 15.

With reference to FIGS. 9-16, in one example of the disclosure, the annular mounting bracket 15 is provided with a plurality of connecting holes 16, and the plurality of connecting holes 16 are arranged at intervals in the circumferential direction of the annular mounting bracket 15. The top mounting bracket 100 includes a first top plate 1110. The top mounting structure for the display device further includes a plurality of fixing screws 1111. The plurality of fixing screws 1111 are arranged in one-to-one correspondence to the plurality of connecting holes 16. The annular mounting bracket 15 is fixedly connected with the first top plate 1110 by the fixing screws 1111.

With reference to FIGS. 9-16, in one example of the disclosure, the top mounting bracket 100 further includes two second top plates 1112. The two second top plates 1112 are fixedly connected with the first top plate 1110, and the two second top plates 1112 are fixedly connected with the ceiling.

With reference to FIGS. 9-16, in one example of the disclosure, the top mounting structure for the display device further includes a second connector 30. The connecting seat 21 is fixedly connected with the top mounting bracket 100 by the second connector 30.

In one example, the second connector 30 is a bolt or a screw.

From the above description, it can be seen that the example of the disclosure achieves the following technical effects: the top mounting bracket, the rotating mechanism and the balancing mechanism are arranged, and the balancing mechanism is connected with the rotating mechanism and is capable of rotating with the rotating mechanism relative to the top mounting bracket. The first position and the first center of gravity are located at the two sides of the rotating axis. When the display device is connected with the connecting assembly, under the abutting force between the first balancing part and the top mounting bracket, a side, tending to tilt up, of the rotating mechanism fails to tilt. Thus, tilting of the rotating mechanism is able to be avoided, stability of the entire structure is able to be ensured, and service life of the mounting structure is able to be prolonged. Meanwhile, appearance of the entire structure is able to be improved, and user experience is able to be enhanced.

### Example 3

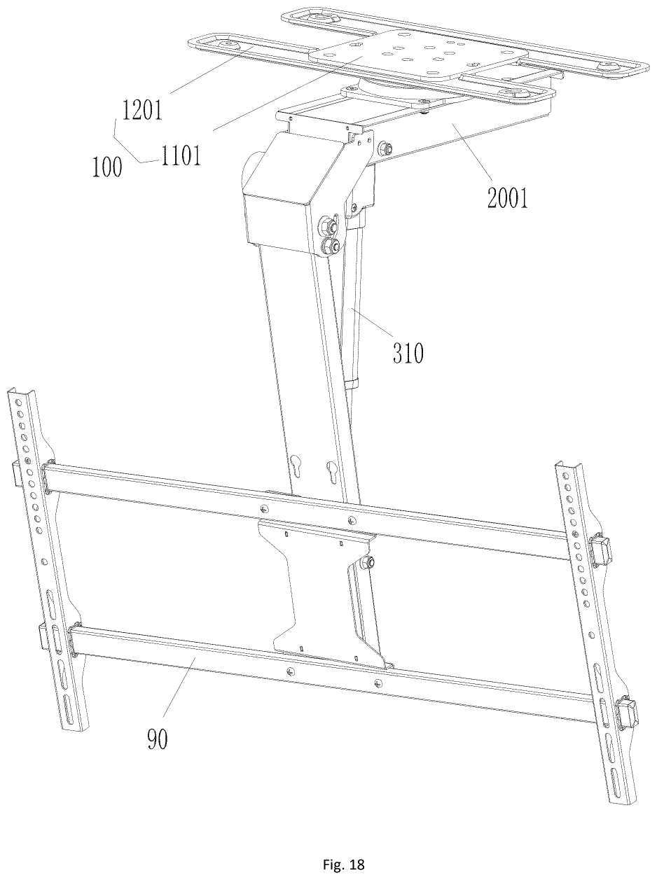

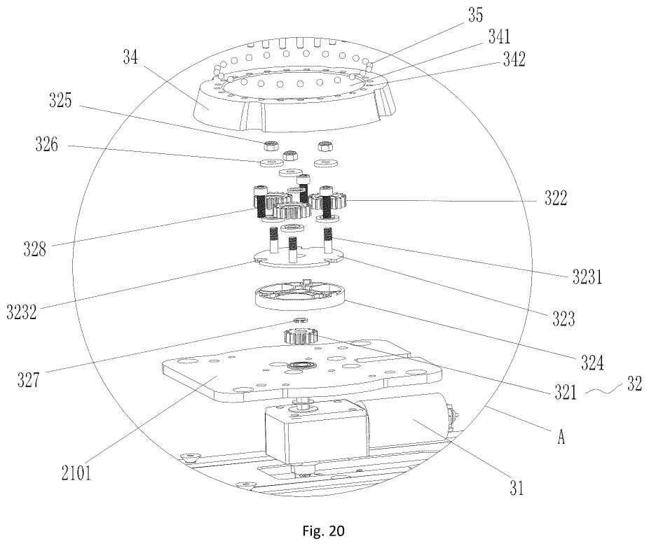

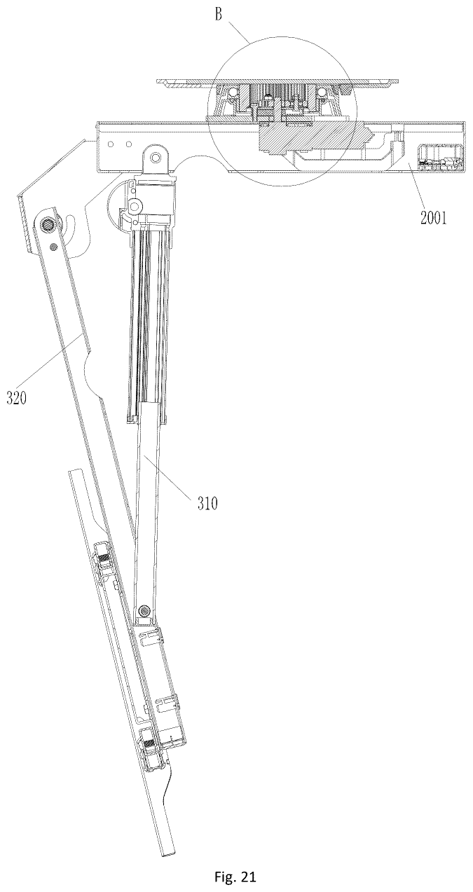

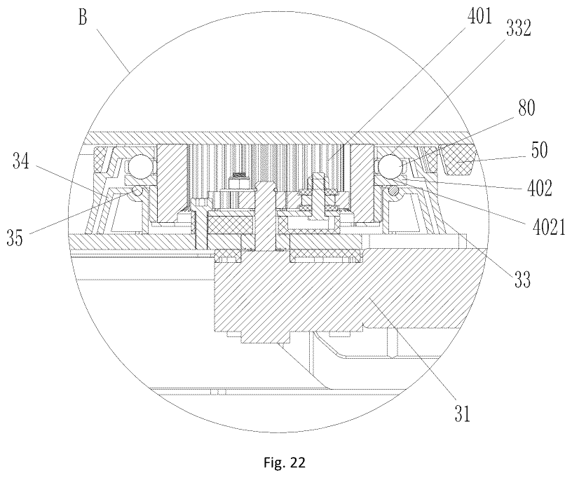

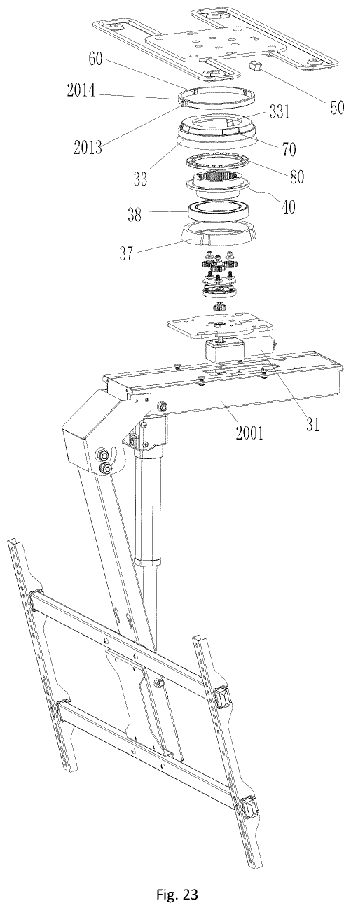

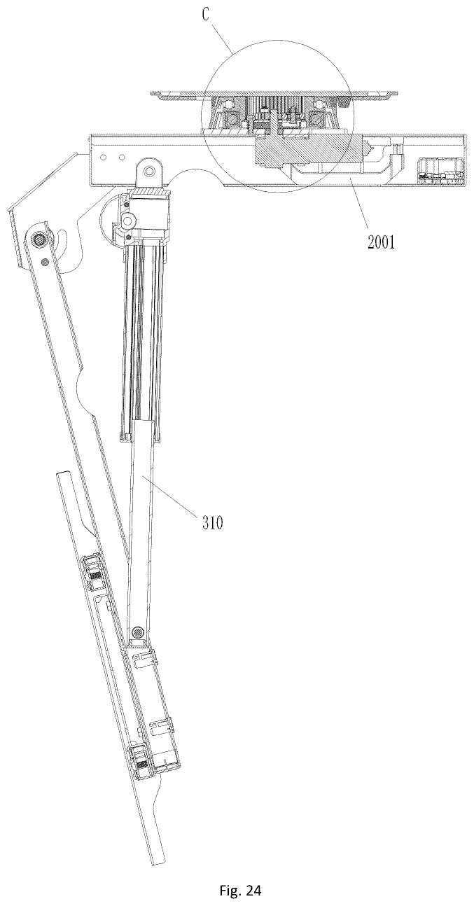

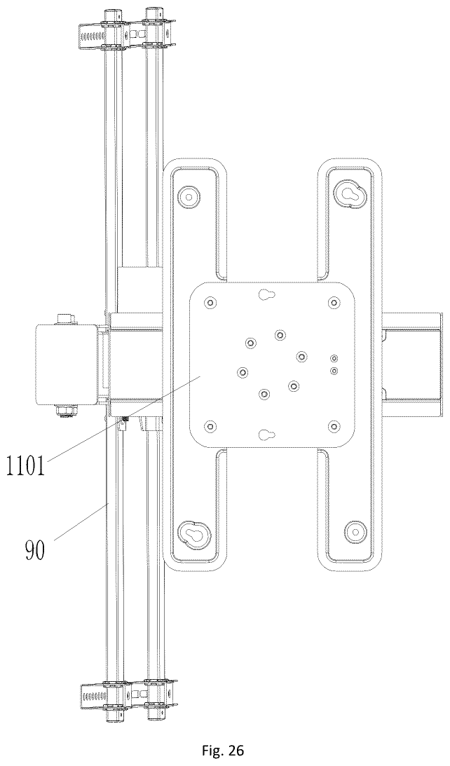

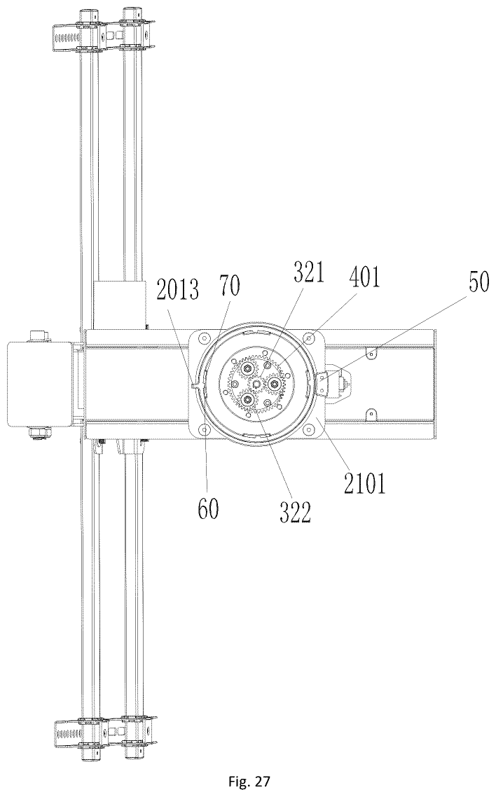

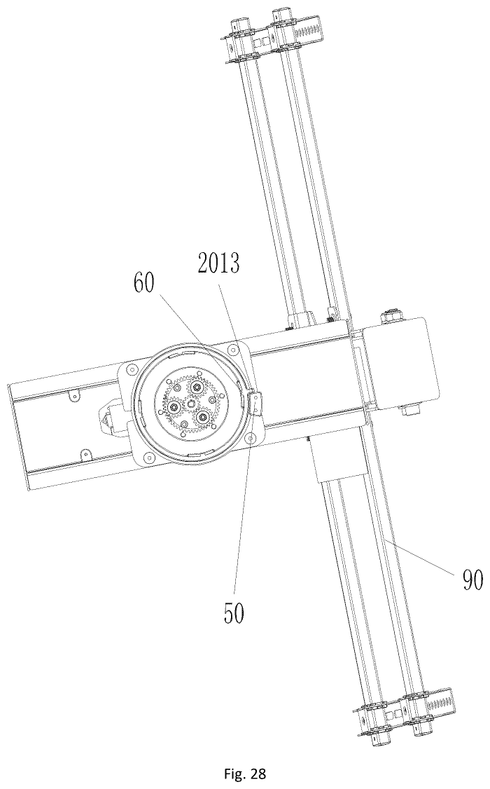

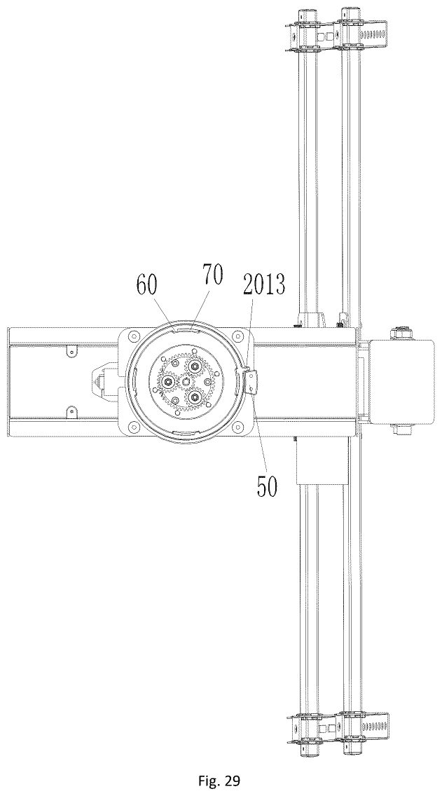

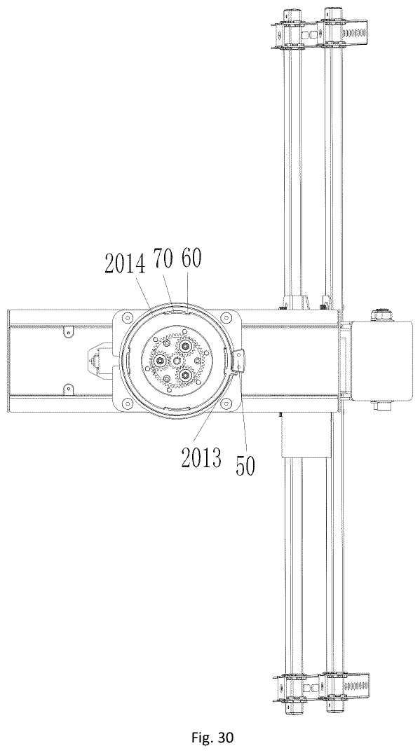

Example 3 of the disclosure provides a top mounting structure for a display device. With reference to FIGS. 18-30, the disclosure provides the top mounting structure for the display device. The top mounting structure for the display device includes: a top mounting bracket 100; a first mounting seat 2001 rotatably connected with the top mounting bracket 100; a connecting structure 40 fixedly connected with the top mounting bracket 100, where a periphery of the connecting structure 40 is fixedly provided with a retaining ring 402; and a rotating mechanism 200 mounted on the first mounting seat 2001. The rotating mechanism 200 includes a fixing seat 33. The fixing seat 33 is connected with the first mounting seat 2001. The fixing seat 33 is located between the top mounting bracket 100 and the first mounting seat 2001. The fixing seat 33 is arranged on the connecting structure 40 in a sleeving manner, and the fixing seat 33 is supported by the retaining ring 402 in a vertical direction.

In the example, the top mounting bracket 100 is fixedly mounted on a to-be-mounted structure (for instance, a ceiling), the first mounting seat 2001 is used to mount a to-be-mounted member (for instance, a display), and the first mounting seat 2001 is rotatably connected with the top mounting bracket 100, such that a rotation angle of the to-be-mounted member is able to be adjusted. The connecting structure 40 is fixedly connected with the top mounting bracket 100, the fixing seat 33 is connected with the first mounting seat 2001, and the retaining ring 402 fixedly arranged on the periphery of the connecting structure 40 is able to support the fixing seat 33 in the vertical direction. That is, an entire weight of the rotating mechanism 200 is borne by the retaining ring 402. Compared with the support in the prior art, the retaining ring has greater bearing capacity, and bearing capacity of the top mounting structure for the display device is improved. Meanwhile, the retaining ring 402 is able to stably support the fixing seat 33 in a circumferential direction, and stability of the rotating mechanism 200 during rotation is ensured. Meanwhile, the fixing seat 33 is connected with the first mounting seat 2001, the fixing seat 33 is arranged on the connecting structure 40 in a sleeving manner, and the fixing seat 33 is supported by the retaining ring 402 in a vertical direction, such that stable connection between the rotating mechanism 200 and the connecting structure 40 is ensured. When the rotating mechanism 200 carries a heavy object, a force is able to be transmitted to the connecting structure 40 by the fixing seat 33, and then transmitted to the top mounting bracket 100 by the connecting structure 40, such that efficiency of force transmission and stability of the structure are improved.

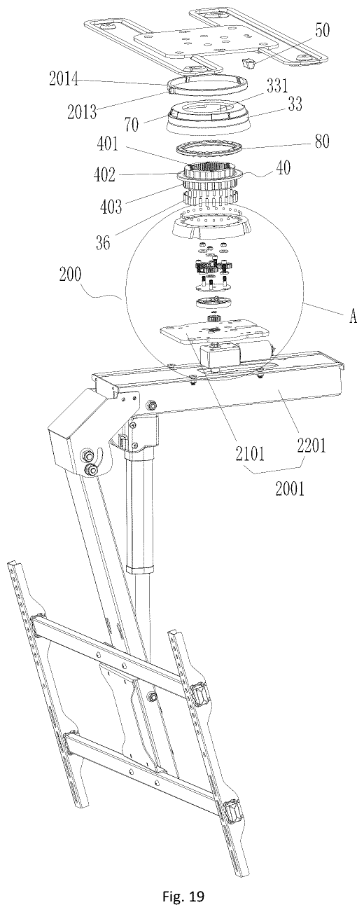

With reference to FIGS. 18-19, in one example of the disclosure, the rotating mechanism 200 further includes a plane bearing 80. The plane bearing 80 is arranged at an end of the connecting structure 40 close to the top mounting bracket 100 in a sleeving manner. A first end surface of the plane bearing 80 abuts against the retaining ring 402. A second end surface of the plane bearing 80 abuts against the fixing seat 33.

In the example, the plane bearing 80 is arranged at the end of the connecting structure 40 close to the top mounting bracket 100 in a sleeving manner, such that friction between the first mounting seat 2001 and the retaining ring 402 in a rotation process is able to be significantly reduced. Rolling balls or needles in the plane bearing 80 are able to convert sliding friction between the first mounting seat and the retaining ring into rolling friction, such that friction is greatly reduced, smoothness and a response speed of rotation of the rotating mechanism 200 are improved, and energy consumption during rotation is reduced. The first end surface of the plane bearing 80 abuts against the retaining ring 402, and the second end surface of the plane bearing 80 abuts against the fixing seat 33, such that stable supporting is able to be implemented. A supporting function of the retaining ring 402 on the fixing seat 33 in the vertical direction is combined with bearing capacity of the plane bearing 80, such that stability of the rotating mechanism 200 in the rotation process is able to be further improved, and structural vibration or deformation caused by rotation of the heavy object is able to be prevented.

In addition, by the arrangement of the plane bearing 80, on one hand, force transmission is more uniform, direct contact between the retaining ring 402 and the fixing seat 33 is avoided, and mechanical damage in long-term use is reduced, such that service life of the rotating mechanism 200 is able to be prolonged. On the other hand, the plane bearing 80 is able to bear large axial load, such that the rotating mechanism 200 is able to provide a sufficient supporting force when bearing a heavy to-be-mounted member, structural deformation or damage caused by a weight of the to-be-mounted member is prevented, and further bearing capacity of the rotating mechanism 200 is improved.

With reference to FIGS. 18-25, in one example of the disclosure, the rotating mechanism 200 further includes a driving part and a transmission part 32. The transmission part 32 includes a first transmission structure and a second transmission structure. The driving part and the second transmission structure are mounted on the first mounting seat 2001. The driving part is connected with the first transmission structure in a driving manner. The first transmission structure is in transmission fit with the second transmission structure. The second transmission structure is in transmission fit with the connecting structure 40.

In the example, the driving part transmits power to the second transmission structure by the first transmission structure. Then, rotation of the rotating mechanism 200 and the first mounting seat 2001 is implemented through transmission fit between the second transmission structure and the connecting structure 40.

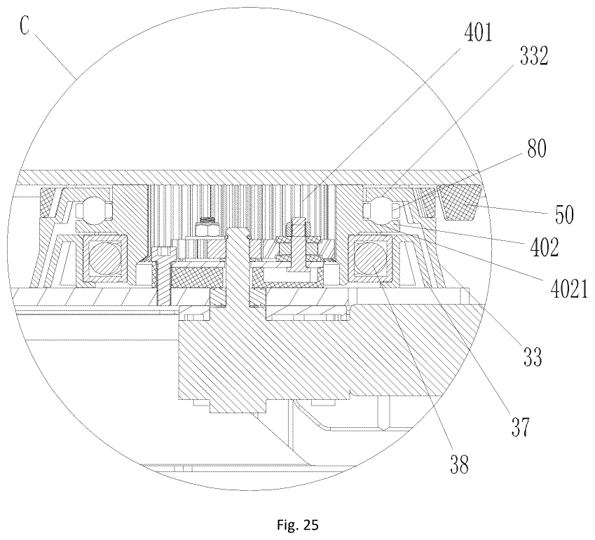

With reference to FIGS. 18 and 25, in one example of the disclosure, the second transmission structure includes at least one transmission gear 322. The first transmission structure is in transmission fit with the at least one transmission gear 322. Each of the at least one transmission gear 322 is meshed with the connecting structure 40.

In the example, gear transmission is able to effectively reduce noise and vibration generated during rotation. Meshing between gears is able to smoothly transmit power, reduce impact and instability in a power transmission process, and make rotation more stable and user experience better.

With reference to FIGS. 18-30, in one example of the disclosure, three transmission gears 322 are provided. The three transmission gears 322 are arranged at intervals in a circumferential direction of the first transmission structure. The plurality of transmission gears 322 are able to distribute a driving force more uniformly, load of a single gear is reduced, and overall efficiency and bearing capacity of a transmission system are improved.

With reference to FIGS. 18-30, in one example of the disclosure, the driving part includes a driving motor 31. The first transmission structure includes a driving gear 321. The driving gear 321 is connected with the driving motor 31 in a driving manner. The driving gear 321 is meshed with the at least one transmission gear 322. An inner circumferential wall of the connecting structure 40 is provided with a gear ring structure 401. Each transmission gear 322 is meshed with the gear ring structure 401.

In the example, the driving gear 321 is fixedly arranged on an output shaft of the driving motor 31 in a sleeving manner. After the driving motor 31 is started, the driving gear 321 is driven to rotate. The driving gear 321 is meshed with the at least one transmission gear 322 and drives the transmission gear 322 meshed with the driving gear 321 to rotate. The remaining transmission gears 322 are able to be in transmission fit with the transmission gear 322 directly driven by the driving gear 321 by a synchronous belt. All the transmission gears 322 are meshed with the gear ring structure 401 on the inner circumferential wall of the connecting structure 40, and the connecting structure 40 is fixedly connected with the top mounting bracket 100. As the connecting structure 40 does not rotate, the first mounting seat 2001 is able to be driven to rotate, such that the to-be-mounted member is rotated.

With reference to FIGS. 18-30, in one example, three transmission gears 322 are provided. The three transmission gears 322 are arranged at intervals along a periphery of the driving gear 321 and are all meshed with the driving gear 321. Meanwhile, the three transmission gears 322 are all meshed with the gear ring structure 401. After the driving motor 31 is started, the driving gear 321 is driven to rotate. The driving gear 321 drives the three transmission gears 322 to rotate. The three transmission gears 322 are all meshed with the gear ring structure 401 on the inner circumferential wall of the connecting structure 40. As the connecting structure 40 does not rotate, the first mounting seat 2001 is able to be driven to rotate, such that the to-be-mounted member is rotated.

With reference to FIGS. 18-30, in one example of the disclosure, the top mounting structure for the display device further includes a first limiting structure 2014. The top mounting bracket 100 is provided with a second limiting structure. The first limiting structure 2014 is mounted on the fixing seat 33. The second limiting structure is located at an outer circumference side of the first limiting structure 2014. The first limiting structure 2014 is configured to rotate relative to the second limiting structure, and is in stop fit with the second limiting structure in a circumferential direction of the second limiting structure.

By the arrangement, a rotation angle of the rotating mechanism 200 is able to be limited to ensure that the rotating mechanism 200 fails to exceed a predetermined rotation range. Thus, structural instability or damage to the top mounting structure for the display device caused by an excessive rotation angle is able to be avoided, and winding caused by excessive rotation is able to be avoided.

With reference to FIGS. 18-30, in one example of the disclosure, the first limiting structure 2014 is capable of rotating relative to the fixing seat 33 by a preset angle. The first limiting structure 2014 is provided with a limiting protrusion 2013. The second limiting structure includes a block 50. The block 50 is located on a rotation path of the limiting protrusion 2013 and is capable of being in stop fit with the limiting protrusion 2013 in a circumferential direction of the limiting protrusion 2013.

In the example, the limiting protrusion 2013 on the first limiting structure 2014 is in stop fit with the block 50. On one hand, the rotation angle of the rotating mechanism 200 is able to be limited, the rotating mechanism 200 is prevented from exceeding a secure rotation range under uncontrolled conditions, the to-be-mounted member is effectively prevented from accidentally tilting or falling in a process of rotating with the first mounting seat 2001, and security risks are reduced. On the other hand, the arrangement is able to implement rotation limitation of the preset angle, such that a user is able to adjust the to-be-mounted member to an ideal use angle more easily, without worrying about exceeding a comfortable or secure range of the device. Meanwhile, wires of the to-be-mounted member (for instance, a display) are able to be prevented from being entangled in the rotation process, and further user experience is improved.

With reference to FIGS. 18-30, in one example of the disclosure, the first limiting structure 2014 is an annular structure. The first limiting structure 2014 is arranged at an end of the fixing seat 33 closer to the top mounting bracket 100 in a sleeving manner. One of an inner circumferential wall of the first limiting structure 2014 and an outer circumferential wall of the first mounting seat 2001 is provided with at least one protruding structure 60, and the other one of the inner circumferential wall of the first limiting structure 2014 and the outer circumferential wall of the first mounting seat 2001 is provided with at least one arc-shaped groove 70. The at least one protruding structure 60 is arranged in one-to-one correspondence to the at least one arc-shaped groove 70. The each of the at least one protruding structure 60 is slidably arranged in a corresponding arc-shaped groove 70 of the at least one arc-shaped groove 70. The block 50 is provided with a first contact surface and a second contact surface. In a circumferential direction of the limiting protrusion 2013, the first contact surface and the second contact surface are capable of being in stop fit with the limiting protrusion 2013. A central angle corresponding to an arc length of a moving path of the protruding structure 60 in the corresponding arc-shaped groove 70 is α, a central angle corresponding to a maximum arc length between the first contact surface and the second contact surface is β, and α is greater than or equal to β.

In the example, the fixing seat 33 is fixedly connected with the first mounting seat 2001, and the first limiting structure 2014 is arranged on the fixing seat 33 in a sleeving manner and is capable of rotating with rotation of the fixing seat 33. Due to arrangement of the protruding structure 60 and the arc-shaped groove 70, the fixing seat 33 is able to continue to rotate even if a first limiting member is in stop fit with the first contact surface of the block 50 in the rotation process. During clockwise rotation, when the limiting protrusion 2013 on the first limiting structure 2014 is in stop fit with the first contact surface of the block 50, the fixing seat 33 continues to rotate clockwise. In this case, the protruding structure 60 slides in the arc-shaped groove 70. When the protruding structure 60 slides to abut against a first end of the arc-shaped groove 70, the fixing seat 33 fails to continue to rotate clockwise, and the rotating mechanism 200 rotates clockwise into position. Similarly, during anticlockwise rotation, when the limiting protrusion 2013 on the first limiting structure 2014 is in stop fit with the first contact surface of the block 50, the fixing seat 33 continues to rotate anticlockwise. In this case, the protruding structure 60 slides in the arc-shaped groove 70, and when the protruding structure 60 slides to abut against a second end of the arc-shaped groove 70, the fixing seat 33 fails to continue to rotate anticlockwise, and the rotating mechanism 200 rotates anticlockwise into position. The central angle α corresponding to an arc length of the moving path of the protruding structure 60 in the corresponding arc-shaped groove 70 is a rotation compensation angle of the rotating mechanism 200. An extension length of the arc-shaped groove 70 is changed, such that a rotating structure is able to rotate by different angles.

With reference to FIGS. 18-30, in one example of the disclosure, four protruding structures 60 and four arc-shaped grooves 70 are provided. The four protruding structures 60 are all arranged on the inner circumferential wall of the first limiting structure 2014, and the four protruding structures 60 are arranged at equal intervals in a circumferential direction of the first limiting structure 2014. The four arc-shaped grooves 70 are all arranged on the outer circumferential wall of the first mounting seat 2001, and the four arc-shaped grooves 70 are arranged at equal intervals in the circumferential direction of the first mounting seat 2001. The four protruding structures 60 are arranged in one-to-one correspondence to the four arc-shaped grooves 70. The protruding structures 60 and the arc-shaped grooves 70 are distributed at equal intervals, such that rotating forces are able to be uniformly dispersed, excessive local stress of the structure caused by concentration of the forces on a certain point is avoided, and stability and reliability of the rotating mechanism 200 are enhanced.

In one example, the central angle α corresponding to the arc length of the moving path of the protruding structure 60 in the corresponding arc-shaped groove 70 is equal to the central angle β corresponding to the maximum arc length between the first contact surface and the second contact surface. In this case, the rotating mechanism 200 is able to drive a second mounting seat 34 to rotate by 180° clockwise or anticlockwise.

In one example, the central angle α corresponding to the arc length of the moving path of the protruding structure 60 in the corresponding arc-shaped groove 70 is greater than the central angle β corresponding to the maximum arc length between the first contact surface and the second contact surface. In this case, the rotating mechanism 200 is able to drive the second mounting seat 34 to rotate by an angle of 180° or above clockwise or anticlockwise.

With reference to FIGS. 18-22, in one example of the disclosure, the rotating mechanism 200 further includes the second mounting seat 34 and a plurality of first rolling members 35. The second mounting seat 34 is mounted on the first mounting seat 2001. The plurality of first rolling members 35 are all arranged on an end surface of the second mounting seat 34 facing the top mounting bracket 100. The plurality of first rolling members 35 are arranged at intervals in a circumferential direction of the second mounting seat 34. Each of plurality of the first rolling members 35 is capable of rotating in a horizontal plane parallel to the top mounting bracket 100. Each of the plurality of first rolling members 35 is supported at a bottom of the retaining ring 402.

In the example, the arrangement of the plurality of first rolling members 35 is able to change the sliding friction between the second mounting seat 34 and the retaining ring 402 into the rolling friction, such that resistance during rotation is greatly reduced. In this way, motion of the rotating mechanism 200 is smoother, and energy loss is reduced. In addition, the plurality of first rolling members 35 are arranged at intervals in the circumferential direction of the second mounting seat 34 and jointly supported at the bottom of the retaining ring 402, such that load of rotation is able to be uniformly distributed to the plurality of first rolling members 35. In this way, stability and reliability of the rotating mechanism 200 during heavy object carrying are improved.

In one example, the first rolling members 35 are spherical structures.

In one example, the first rolling members 35 are steel balls.

With reference to FIGS. 18-22, in one example of the disclosure, the second mounting seat 34 is provided with a first through hole 341 through which an end of the connecting structure 40 away from the top mounting bracket 100 penetrates. The rotating mechanism 200 further includes a plurality of second rolling members 36. An outer circumferential surface of the connecting structure 40 is provided with a plurality of mounting recesses 403. The plurality of second rolling members 36 are arranged in one-to-one correspondence to the plurality of mounting recesses 403. Each of the plurality of second rolling members 36 is rotatably arranged in a corresponding mounting recesses 403 of the plurality of mounting recesses 403. Each of the plurality of second rolling members 36 is capable of rotating in the corresponding mounting recess 403 of the plurality of mounting recesses 403. The plurality of second rolling members 36 are located at a side of the retaining ring 402 facing away from the top mounting bracket 100. Part of each of the plurality of the second rolling members 36 outside the corresponding mounting recess 403 of the plurality of mounting recesses 403 is in contact with an inner wall of the first through hole 341.

In the example, use of the second rolling members 36 reduces friction of the connecting structure 40 in a rotation process. By the second rolling members 36 freely rotating in the mounting recesses 403, the sliding friction is changed into the rolling friction, such that resistance in the rotation process is greatly reduced. In this way, rotation is smoother, and operation is more labor-saving. Rolling of the second rolling members 36 in the mounting recesses 403 is able to reduce direct contact between an outer wall of the connecting structure 40 and an inner wall of the second mounting seat 34, reduce wear, and prolong service life of the rotating mechanism 200.

With reference to FIGS. 18 and 23-25, in one example of the disclosure, the rotating mechanism 200 further includes a bearing seat 37 and a rolling bearing 38. The bearing seat 37 is mounted on the first mounting seat 2001, and the rolling bearing 38 is mounted on the bearing seat 37. An end of the connecting structure 40 away from the top mounting bracket 100 penetrates an inner ring of the rolling bearing 38.

By the arrangement, on one hand, friction of the rotating mechanism 200 in the rotation process is able to be reduced, and service life of the rotating mechanism 200 is able to be prolonged. On the other hand, the rolling bearing 38 has strong bearing capacity, such that radial load and axial load generated by the connecting structure 40 during rotation are able to be effectively dispersed and borne, and the rotating mechanism 200 is still able to keep stable rotation in a case of bearing a great weight.

With reference to FIGS. 18-30, in one example of the disclosure, an end surface of the fixing seat 33 facing the plane bearing 80 is provided with a first annular recess 332. A side of the retaining ring 402 facing the plane bearing 80 is provided with a second annular recess 4021. A top of the plane bearing 80 is matched with the first annular recess 332, and a bottom surface of the plane bearing 80 is matched with the second annular recess 4021.

In the example, the plane bearing 80 is matched with the first annular recess 332 and the second annular recess 4021, such that structural stability and compactness of the rotating mechanism 200 are able to be ensured, relative movement between components is able to be effectively reduced, and vibration and noise during rotation are able to be reduced.

With reference to FIGS. 18-30, in one example of the disclosure, the top mounting bracket 100 further includes a top plate 1101 and two connecting plates 1201. The two connecting plates 1201 are arranged at intervals. The two connecting plates 1201 are fixedly connected with the top plate 1101. Meanwhile, the two top plates 1101 are fixedly connected with the to-be-mounted structure (for instance, a ceiling).

With reference to FIGS. 18-30, in one example of the disclosure, the fixing seat 33 is provided with a second through hole 331. An end of the connecting structure 40 away from the first mounting seat 2001 is able to be fixedly connected with the top plates 1101 after penetrating the second through hole 331. The second mounting seat 34 is provided with the second through hole 331 and a plurality of mounting holes 342. The second through hole 331 is provided corresponding to the first through hole 341. An end of the connecting structure 40 close to the first mounting seat 2001 is able to penetrate the second through hole 331. The plurality of first rolling members 35 are provided, and the plurality of first rolling members 35 are arranged in one-to-one correspondence to the plurality of mounting holes 342. Each of the first rolling members 35 is mounted in the corresponding mounting hole 342 and rotates in the mounting hole 342.

With reference to FIGS. 18-25, in one example of the disclosure, the first mounting seat 2001 includes a mounting plate 2101 and a top seat 2201. The top seat 2201 is provided with a mounting cavity, and the driving motor 31 is mounted in the mounting cavity. The output shaft of the driving motor 31 extends out of the mounting cavity. The mounting plate 2101 is fixedly connected with the top seat 2201. The mounting plate 2101 is provided with a third through hole through which the output shaft of the driving motor 31 penetrates. The fixing seat 33 is fixedly connected with the mounting plate 2101. The rotating mechanism 200 further includes a third mounting seat 323, a first mounting frame 324, three nuts 325, three gaskets 326, three bolts 328, and a snap spring 327. The first mounting frame 324 is fixedly connected with the mounting plate 2101 by the three bolts 328. The third mounting seat 323 is mounted on the first mounting frame 324. An outer edge of the third mounting seat 323 is provided with three clamping slots 3232. The three bolts 328 are arranged in one-to-one correspondence to the three clamping slots 3232. An end of each of the bolts 328 away from the mounting plate 2101 is clamped in a corresponding clamping slot 3232, such that limiting is conducted in a circumferential direction of the first mounting frame 324. Three transmission gears 322 are provided. The third mounting seat 323 is provided with three mounting shafts 3231. The mounting shafts 3231 each include a smooth section and a threaded section located above the smooth section. The three transmission gears 322 are arranged in one-to-one correspondence to the three mounting shafts 3231. Each of the transmission gears 322 is arranged on the smooth section of a corresponding mounting shaft 3231 in a sleeving manner. The three gaskets 326 are arranged in one-to-one correspondence to the three mounting shafts 3231. Each of the gaskets 326 is arranged on the smooth section of the corresponding mounting shaft 3231 in a sleeving manner. The gaskets are located at a side of the transmission gears 322 away from the mounting plate 2101. The three nuts 325 are arranged in one-to-one correspondence to the three threaded sections. Each of the nuts 325 is matched with the threaded section in a threaded manner. The nuts 325 are located at a side of the gaskets 326 away from the mounting plate 2101, such that the transmission gears 322 are prevented from being separated from the mounting shaft 3231. The snap spring 327 is arranged on the output shaft of the driving motor 31 in a sleeving manner and located above the driving gear 321, such that the driving gear 321 is prevented from being separated from the output shaft of the driving motor 31.

In one example, the first mounting frame 324 is a planet carrier.

With reference to FIGS. 18-30, in one example of the disclosure, the top mounting structure for the display device further includes a second mounting frame 90, a movable arm 320, and an electric push rod 310. The second mounting frame 90 is rotatably connected with the first mounting seat 2001 by the movable arm 320, the second mounting frame 90 is used to mount a to-be-mounted member (for instance, a display), and an end of the electric push rod 310 is fixedly connected with the first mounting seat 2001. A telescopic end of the electric push rod 310 is connected with the second mounting frame 90, and the electric push rod 310 extends and contracts to drive the second mounting frame 90 to rotate close to or away from the first mounting seat 2001, such that a pitch angle of the to-be-mounted member (for instance, a display) is adjusted.

From the above description, it can be seen that the examples of the disclosure achieve the following technical effects: a base, the first mounting seat, the connecting structure and the rotating mechanism are provided, the base is fixedly mounted on the to-be-mounted structure (for instance, the ceiling), the first mounting seat is used to mount the to-be-mounted member (for instance, the display), and the first mounting seat is rotatably connected with the base, such that the rotation angle of the to-be-mounted member is able to be adjusted. The connecting structure is fixedly connected with the base, the fixing seat is connected with the first mounting seat, and the retaining ring fixedly arranged on the periphery of the connecting structure is able to support the fixing seat in the vertical direction. That is, an entire weight of the rotating mechanism is borne by the retaining ring. Compared with the support in the prior art, the retaining ring has greater bearing capacity, and bearing capacity of the top mounting structure for the display device is improved. Meanwhile, the retaining ring is able to stably support the fixing seat in a circumferential direction of the fixing seat, and stability of the rotating mechanism during rotation is ensured.

What are described above is merely some examples of the disclosure and is not intended to limit the protection scope of the disclosure. Any modifications, equivalent substitutions, improvements, etc. within the spirit and principles of the disclosure shall fall within the protection scope of the disclosure.

1. A top mounting structure for a display device, comprising: a top mounting bracket and a connecting assembly, wherein the connecting assembly comprises a rotating mechanism and a deployment and retraction mechanism;
the top mounting bracket is used to be fixedly connected with a top ceiling;
the rotating mechanism is rotatably connected with the top mounting bracket;
the deployment and retraction mechanism is arranged below the rotating mechanism, and an upper portion of the deployment and retraction mechanism is connected with the rotating mechanism; and
the deployment and retraction mechanism comprises a telescopic part and a movable arm that are connected with each other, wherein the telescopic part is an electric push rod, the telescopic part is capable of driving the movable arm to rotate relative to the top mounting bracket, and the movable arm is suitable for being directly or indirectly connected with the display device, so as to adjust a pitch angle of the display device relative to the top mounting bracket.

2. The top mounting structure for the display device according to claim 1, further comprising a mounting frame and a television mounting bracket, wherein the television mounting bracket is fixedly or rotatably connected with the movable arm, the television mounting bracket is configured for mounting the display device, the rotating mechanism is fixedly arranged on the mounting frame, a first end of the electric push rod is hinged to the mounting frame, a second end of the electric push rod is hinged to the movable arm, and the electric push rod extends or shortens to adjust an included angle between the movable arm and the mounting frame.

3. The top mounting structure for the display device according to claim 2, wherein the top mounting bracket comprises: a top plate and a connecting mechanism; the top plate is used to be fixedly connected with the top ceiling; the connecting mechanism is arranged between the top plate and the mounting frame, and a top of the connecting mechanism is fixedly connected with the top plate; and the connecting mechanism is rotatably connected with the rotating mechanism, and the rotating mechanism is capable of driving the mounting frame to rotate.

4. The top mounting structure for the display device according to claim 2, wherein the deployment and retraction mechanism further comprises a fixed arm, a first end of the fixed arm is fixedly connected with the mounting frame, and a second end of the fixed arm is hinged to an end of the movable arm away from the television mounting bracket.

5. The top mounting structure for the display device according to claim 4, wherein one of the fixed arm and the movable arm is provided with an arc-shaped groove, the other one of the fixed arm and the movable arm is provided with a fixing pin, and in a rotation process of the movable arm, the fixing pin is able to move in the arc-shaped groove.

6. The top mounting structure for the display device according to claim 1, further comprising a balancing mechanism, wherein the balancing mechanism comprises a first balancing part, the first balancing part is connected with the connecting assembly, the first balancing part is configured to abut against the top mounting bracket, an abutting position of the first balancing part and the top mounting bracket is a first position, when the top mounting structure for the display device is in a first use state, a center of gravity of the connecting assembly on which the display device is mounted is a first center of gravity, and the first position and the first center of gravity are located at two sides of a rotating axis in a radial direction of the rotating axis of the connecting assembly.

7. The top mounting structure for the display device according to claim 6, wherein an abutting surface of the first balancing part and the top mounting bracket is an arc-shaped convex surface; or, the first balancing part comprises a rolling member, and the rolling member is capable of rolling relative to the top mounting bracket.

8. The top mounting structure for the display device according to claim 7, wherein when the first balancing part comprises the rolling member, the top mounting bracket comprises a guiding structure, the guiding structure comprises a guide groove, and the rolling member is arranged in the guide groove in a rolling manner.

9. The top mounting structure for the display device according to claim 8, wherein the guiding structure further comprises an annular mounting bracket, the guide groove is provided on the annular mounting bracket, and the annular mounting bracket is detachably connected with the top mounting bracket.

10. The top mounting structure for the display device according to claim 9, wherein the annular mounting bracket comprises an inner ring, an outer ring, and a plurality of reinforcing ribs, the guide groove is annular, the guide groove is provided between the inner ring and the outer ring, the plurality of reinforcing ribs are arranged at intervals in a circumferential direction of the annular mounting bracket, and the reinforcing ribs are connected between the inner ring and the outer ring and are capable of supporting the guide groove.

11. The top mounting structure for the display device according to claim 7, wherein when the first balancing part comprises the rolling member, the first balancing part further comprises a rolling member mounting seat, the rolling member mounting seat is connected with the connecting assembly, the rolling member is spherical, and the rolling member is mounted on the rolling member mounting seat.

12. The top mounting structure for the display device according to claim 6, wherein the balancing mechanism further comprises a second balancing part, the first balancing part and the second balancing part are symmetrically arranged with respect to the rotating axis, the second balancing part abuts against the top mounting bracket, an abutting position of the second balancing part and the top mounting bracket is a second position, when the top mounting structure for the display device is in a second use state, a center of gravity of the connecting assembly on which the display device is mounted is a second center of gravity, and the second position and the second center of gravity are located at two sides of the rotating axis in the radial direction of the rotating axis of the connecting assembly.

13. The top mounting structure for the display device according to claim 1, further comprising a first mounting seat and a connecting structure, wherein the first mounting seat is rotatably connected with the top mounting bracket, the connecting structure is fixedly connected with the top mounting bracket, and a periphery of the connecting structure is fixedly provided with a retaining ring; and the rotating mechanism comprises a fixing seat, the fixing seat is connected with the first mounting seat, the fixing seat is located between the top mounting bracket and the first mounting seat, the fixing seat is sleeved on the connecting structure, and the fixing seat is supported by the retaining ring in a vertical direction.

14. The top mounting structure for the display device according to claim 13, wherein the rotating mechanism further comprises a plane bearing, the plane bearing is sleeved on an end of the connecting structure close to the top mounting bracket, a first end surface of the plane bearing abuts against the retaining ring, and a second end surface of the plane bearing abuts against the fixing seat.

15. The top mounting structure for the display device according to claim 13, wherein the rotating mechanism further comprises a driving part and a transmission part, the transmission part comprises a first transmission structure and a second transmission structure, the driving part and the second transmission structure are mounted on the first mounting seat, the driving part is connected with the first transmission structure in a driving manner, the first transmission structure is in transmission fit with the second transmission structure, the second transmission structure is in transmission fit with the connecting structure, the second transmission structure comprises at least one transmission gear, the first transmission structure is in transmission fit with the at least one transmission gear, each of the at least one transmission gear is meshed with the connecting structure, the driving part comprises a driving motor, the first transmission structure comprises a driving gear, the driving gear is connected with the driving motor in a driving manner, the driving gear is meshed with the at least one transmission gear, an inner circumferential wall of the connecting structure is provided with a gear ring structure, and the each of the at least one transmission gear is meshed with the gear ring structure.

16. The top mounting structure for the display device according to claim 13, further comprising a first limiting structure, wherein the top mounting bracket is provided with a second limiting structure, the first limiting structure is mounted on the fixing seat, the second limiting structure is located at an outer circumference side of the first limiting structure, and the first limiting structure is configured to be capable of rotating relative to the second limiting structure, and is in stop fit with the second limiting structure in a circumferential direction of the second limiting structure.

17. The top mounting structure for the display device according to claim 16, wherein the first limiting structure is capable of rotating relative to the fixing seat by a preset angle, the first limiting structure is provided with a limiting protrusion, the second limiting structure comprises a block, and the block is located on a rotation path of the limiting protrusion and is capable of being in stop fit with the limiting protrusion in a circumferential direction of the limiting protrusion.

18. The top mounting structure for the display device according to claim 17, wherein the first limiting structure is an annular structure, the first limiting structure is sleeved on an end of the fixing seat close to the top mounting bracket, one of an inner circumferential wall of the first limiting structure and an outer circumferential wall of the first mounting seat is provided with at least one protruding structure, the other one of the inner circumferential wall of the first limiting structure and the outer circumferential wall of the first mounting seat is provided with at least one arc-shaped groove, the at least one protruding structure is arranged in one-to-one correspondence to the at least one arc-shaped groove, each of the at least one protruding structure is slidably arranged in a corresponding arc-shaped groove of the at least one arc-shaped groove, the block is provided with a first contact surface and a second contact surface, in a circumferential direction of the limiting protrusion, the first contact surface and the second contact surface are capable of being in stop fit with the limiting protrusion, a central angle corresponding to an arc length of a moving path of the each of the at least one protruding structure in the corresponding arc-shaped groove of the at least one arc-shaped groove is α, a central angle corresponding to a maximum arc length between the first contact surface and the second contact surface is β, and α is greater than or equal to β.

19. The top mounting structure for the display device according to claim 13, wherein the rotating mechanism further comprises a second mounting seat and a plurality of first rolling members, the second mounting seat is mounted on the first mounting seat, the plurality of first rolling members are arranged on an end surface of the second mounting seat facing the top mounting bracket, the plurality of first rolling members are arranged at intervals in a circumferential direction of the second mounting seat, each of the plurality of first rolling members is capable of rotating in a horizontal plane parallel to the top mounting bracket, and the each of the plurality of first rolling members is supported at a bottom of the retaining ring.

20. The top mounting structure for the display device according to claim 19, wherein the second mounting seat is provided with a first through hole through which an end of the connecting structure away from the top mounting bracket penetrates, the rotating mechanism further comprises a plurality of second rolling members, an outer circumferential surface of the connecting structure is provided with a plurality of mounting recesses, the plurality of second rolling members are arranged in one-to-one correspondence to the plurality of mounting recesses, each of the plurality of second rolling members is rotatably arranged in a corresponding mounting recess of the plurality of mounting recesses, the each of the plurality of second rolling members is capable of rotating in the corresponding mounting recess of the plurality of mounting recesses, the plurality of second rolling members are located at a side of the retaining ring away from the top mounting bracket, and part of the each of the plurality of the second rolling members outside the corresponding mounting recess of the plurality of mounting recesses is in contact with an inner wall of the first through hole.
